(19) United States
(12) Patent Application Publication
(10) Pub. No.: US 2025/0125467 A1
(43) Pub. Date: Apr. 17, 2025

(54) POWER EQUIPMENT HAVING A SWAPPABLE BATTERY PACK

(71) Applicant: BRIGGS & STRATTON, LLC, Wauwatosa, WI (US)

(72) Inventors: Nathan Jasinski, Wauwatosa, WI (US); Stephen Bryan Avery, Milwaukee, WI (US); Steven Henkel, Wauwatosa, WI (US); Ray Wolf, Wauwatosa, WI (US); Josue Pimentel Lozano, Wauwatosa, WI (US)

(73) Assignee: BRIGGS & STRATTON, LLC, Wauwatosa, WI (US)

(21) Appl. No.: 18/915,307

(22) Filed: Oct. 14, 2024

Related U.S. Application Data
(60) Provisional application No. 63/544,580, filed on Oct. 17, 2023.
(60) Provisional application No. 63/653,039, filed on May 29, 2024.

(51) Int. Cl. H01M 50/244; H02J 7/00

(52) U.S. Cl. CPC H01M 50/244; H02J 7/0045

(57) ABSTRACT

Power equipment includes a base, a swappable battery pack, an electric motor powered by the swappable battery pack, a motor controller electrically coupled to the electric motor, and a battery holder or bracket coupled to the base. The battery holder includes a dock connector. The swappable battery pack is coupled to the dock connector and arranged within or on the battery holder so that the swappable battery pack is arranged at an angle relative to the base.

### CROSS-REFERENCE TO RELATED PATENT APPLICATIONS

This application claims the benefit of and priority to U.S. Provisional Patent Application No. 63/653,039, filed May 29, 2024, and U.S. Provisional Patent Application No. 63/544,580, filed Oct. 17, 2023, each of which is incorporated herein by reference in its entirety.

### BACKGROUND

Power equipment or chore products typically include an implement (e.g., a motor, a pump, a fan, etc.) that performs a task or chore.

### SUMMARY

At least one embodiment relates to power equipment that includes a base, a swappable battery pack, an electric motor powered by the swappable battery pack, a motor controller electrically coupled to the electric motor, and a battery holder or bracket coupled to the base. The battery holder includes a dock connector. The swappable battery pack is coupled to the dock connector and arranged within or on the battery holder so that the swappable battery pack is arranged at an angle relative to the base.

At least one embodiment relates to power equipment that includes a swappable battery pack, an electric motor powered by the swappable battery pack, a motor controller electrically coupled to the electric motor, a battery holder including a first sidewall and a second sidewall, and a motor controller housing enclosing the motor controller and coupled to an outer surface of the first sidewall. The battery holder includes a dock connector coupled to an inner surface of the first sidewall. The swappable battery pack is coupled to the dock connector and arranged within a cavity defined between the first sidewall and the second sidewall.

At least one embodiment relates to power equipment that includes a base, a swappable battery pack, an electric motor powered by the swappable battery pack, a motor controller electrically coupled to the electric motor, and a battery holder or bracket coupled to the base. The battery holder includes a dock connector. The swappable battery pack is coupled to the dock connector and arranged within or on the battery holder, and wherein the base defines a central axis and the battery holder and the swappable battery pack are laterally offset from the central axis.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIGS. 1-7 show various views of power equipment in the form of an aerator, according to an exemplary embodiment;

FIGS. 8-10 show various views of a battery mounting bracket of the aerator of FIGS. 1-7;

FIGS. 11-15 show various views of power equipment in the form of an aerator, according to an exemplary embodiment;

FIGS. 16-26 show various views of power equipment in the form of a blower, according to an exemplary embodiment;

FIGS. 27-28 show various views of a battery mounting bracket of the blower of FIGS. 23-26;

FIGS. 29-31 show various views of power equipment in the form of a turf rake, according to an exemplary embodiment;

FIGS. 32-37 show various views of power equipment in the form of an edge grinder, according to an exemplary embodiment;

FIGS. 38-42 show various view of power equipment in the form of a trowel, according to an exemplary embodiment;

FIGS. 43-47 show various views of a battery housing of the trowel of FIGS. 38-42;

FIGS. 48-52 various view of power equipment in the form of a trowel, according to an exemplary embodiment;

FIGS. 53-55 various view of power equipment in the form of a light tower, according to an exemplary embodiment;

FIGS. 56-58 show various views of power equipment in the form of a floor grinder, according to an exemplary embodiment;

FIGS. 59-63 show various views of power equipment in the form of a concrete grinder, according to an exemplary embodiment;

FIGS. 64-67 show various views of power equipment in the form of a concrete saw, according to an exemplary embodiment;

FIGS. 68-72 show various views of a battery housing;

FIGS. 73-76 show various views of power equipment in the form of a floor grinder, according to an exemplary embodiment; and

FIGS. 77-80 show various views of power equipment in the form of a concrete saw, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The use herein of the term “axial” and variations thereof refers to a direction that extends generally along an axis of symmetry, a central axis, or an elongate direction of a particular component or system. For example, axially extending features of a component may be features that extend generally along a direction that is parallel to an axis of symmetry or an elongate direction of that component. Similarly, the use herein of the term “radial” and variations thereof refers to directions that are generally perpendicular to a corresponding axial direction. For example, a radially extending structure of a component may generally extend at least partly along a direction that is perpendicular to a longitudinal or central axis of that component. The use herein of the term “circumferential” and variations thereof refers to a direction that extends generally around a circumference of an object or around an axis of symmetry, a central axis or an elongate direction of a particular component or system.

Referring to the figures generally, the swappable battery pack described herein may be used in chore products, including outdoor power equipment, standby generators, portable jobsite equipment, or other appropriate uses. Outdoor power equipment may include lawn mowers, riding tractors, snow throwers, pressure washers, portable generators, tillers, log splitters, zero-turn radius mowers, walk-behind mowers, wide-area walk-behind mowers, riding mowers, standing mowers, aerators, blowers, edge grinders, turf rakes, trowels, golf carts, industrial vehicles such as forklifts, utility vehicles, etc. Outdoor power equipment may, for example, use a power source (e.g., a battery pack) to drive an implement, such as a rotary blade of a lawn mower, a pump of a pressure washer, an auger of a snow thrower, the alternator of a generator, and/or a drivetrain of the outdoor power equipment. Portable jobsite equipment includes portable light towers, mobile industrial heaters, and portable light stands.

A “chore product” as used herein refers to any type of equipment, machine, or vehicle that may be used to perform a chore (e.g., an outdoor chore, an indoor chore, lawn care, etc.). For example, a chore product may include a motor, a pump, an actuator, a compressor, and/or another device that is electrically powered to operate some function of the chore product to facilitate performing a chore. In some embodiments, a chore is a task performed, either by a user or autonomously, at or near a household, a farm, an agricultural facility, a golf course, a building, a sidewalk, a park, a parking lot, a forest, a field, and/or a lawn. In some embodiments, a chore product transports an operator and performs a chore. In some embodiments, a chore product autonomously operates to perform a chore without an operator being present on the chore product or physically/manually manipulating the chore product.

In general, the present disclosure describes various forms of chore products or power equipment (e.g., outdoor and/or indoor) that include a swappable battery pack that powers, for example, a motor, a pump, a light assembly, and/or a fan. The chore products or power equipment described herein are conventionally powered using an internal combustion engine (ICE) and retrofitting the chore products or power equipment to include a swappable battery pack, an electric motor, and a motor controller provides several operational advantages. For example, liquid hydrocarbon fuels and oils are no longer required for operation, which reduces the maintenance (e.g., no oil changes) and provides clean operation (e.g., no fumes or exhaust gases). In some instances, the clean operation enables the power equipment or chore product to be used indoors when it was otherwise not possible due to exhaust fumes. Additionally, the incorporation of a battery pack eliminates hard starting associated with ICE startup, and the vibration/noise associated with running an ICE is eliminated. Further, a battery pack and electric motor controller enables variable speed control that can be spontaneously adjusted (e.g., frequency-based AC motors typically run at one speed because wall power is a single frequency, and DC power provided by a battery enables speed control), and the power equipment or chore product may not be required to include a clutch. Further still, a battery pack may provide instantaneous torque and the electric motor/fan/pump powered by the battery pack be the tuned for optimal application performance.

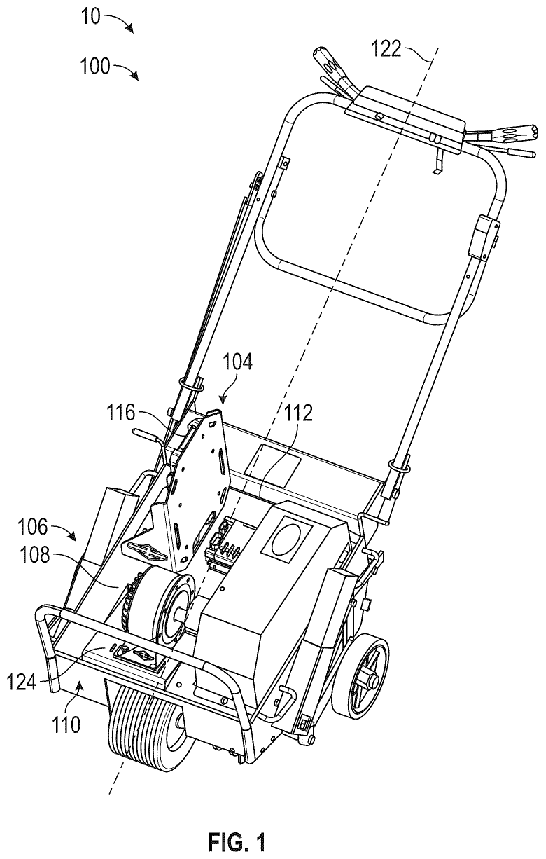

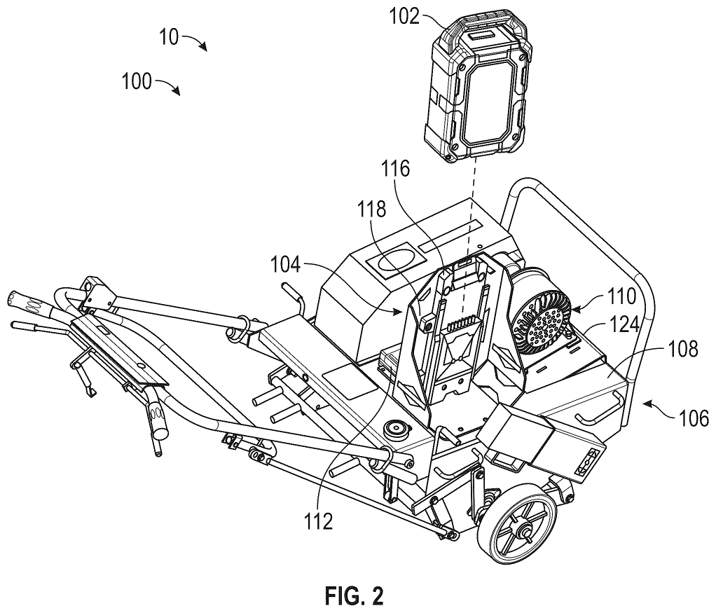

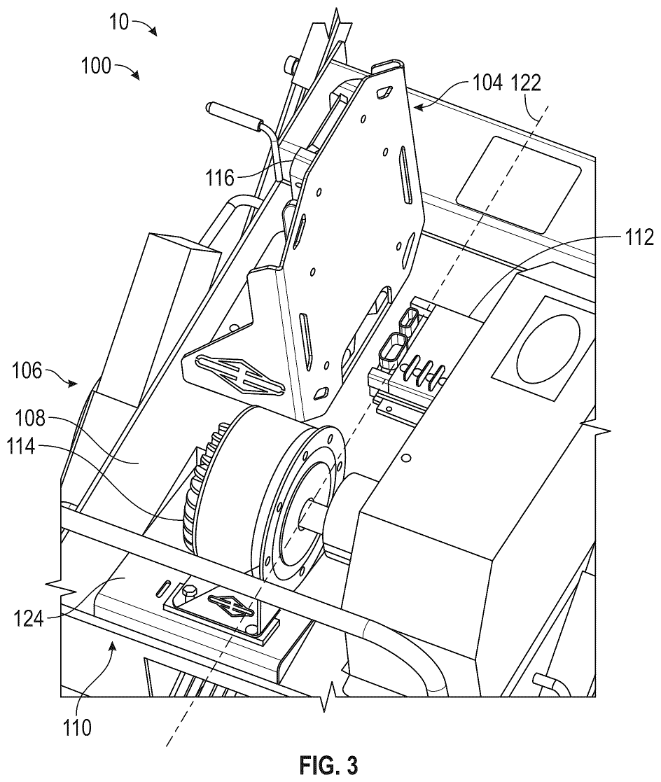

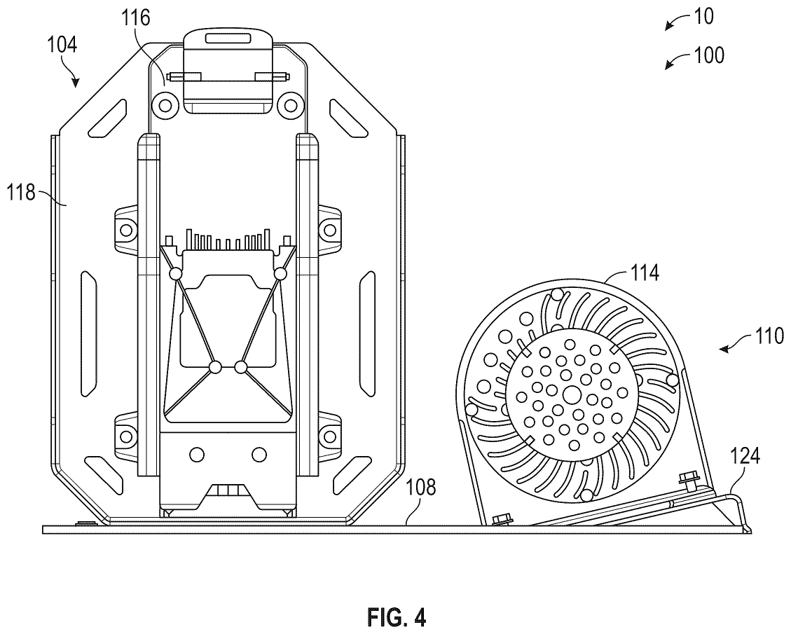

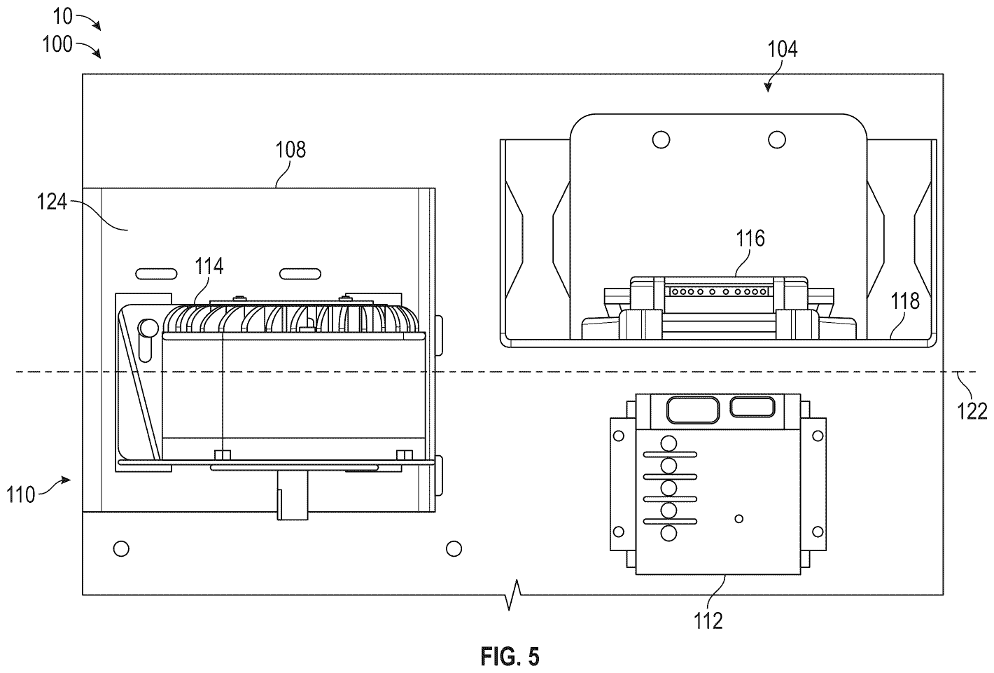

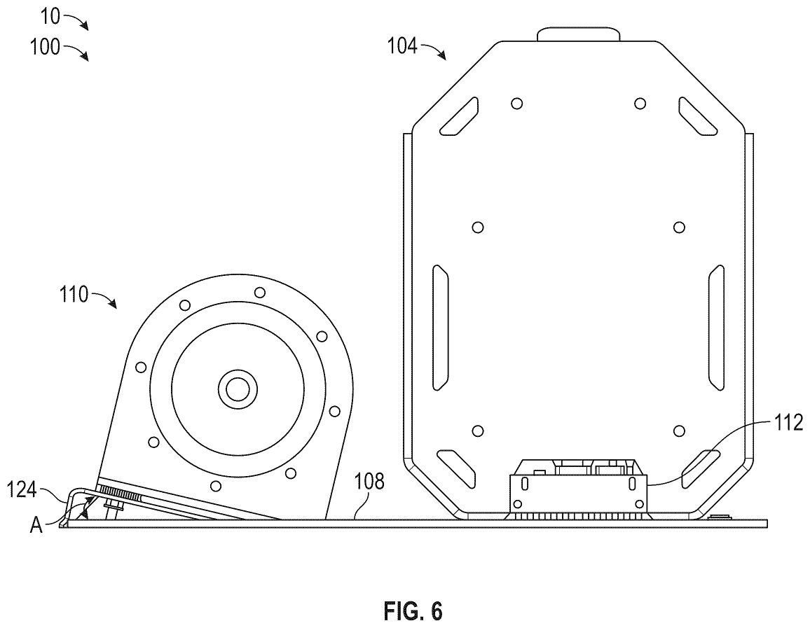

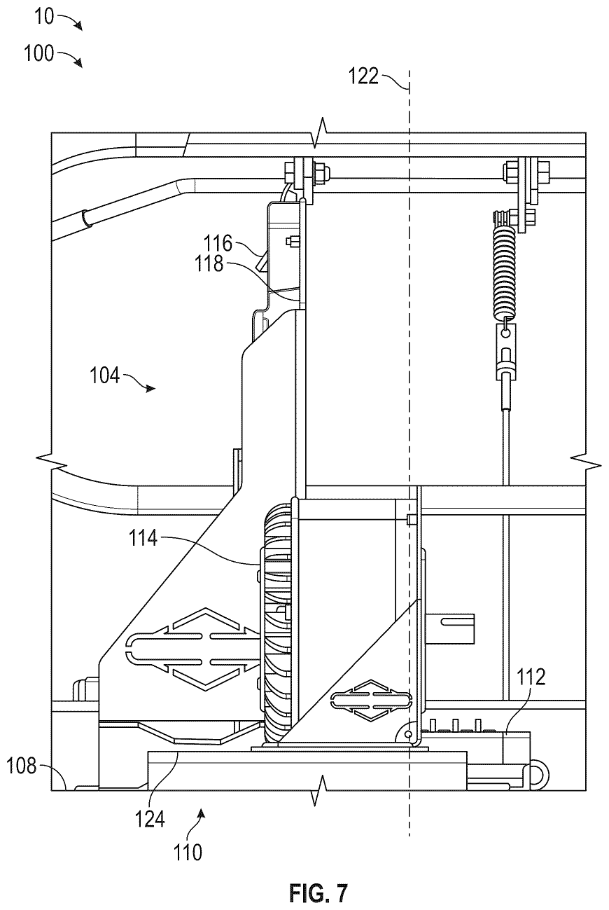

FIGS. 1-7 show a chore product or power equipment 10, according to an exemplary embodiment. In the illustrated embodiment, the chore product or power equipment 10 is in the form of an aerator 100. The aerator 100 is powered by a swappable battery pack 102 that is received within a battery holder or mounting bracket 104. The battery mounting bracket 104 is coupled to and supported on a body or housing 106 of the aerator 100. Specifically, the housing 106 includes a housing surface 108 (e.g., a top or upper surface) that supports the battery mounting bracket 104, a motor mounting bracket 110, and a motor controller 112. The motor mounting bracket 110 supports and is coupled to an electric motor or chore motor 114. In the illustrated embodiment, the motor controller 112 is coupled to the housing surface 108. In some embodiments, the motor controller 112 may be coupled to the battery mounting bracket 104.

The battery mounting bracket 104 is coupled to a battery dock connector 116. Specifically, the battery dock connector 116 is coupled to an inner surface 118 of the battery mounting bracket 104. The battery dock connector 116 is configured to electrically connect to a connector on the swappable battery pack 102. When the swappable battery pack 102 is electrically coupled to and secured by the battery dock connector 116, the swappable battery pack 102 is configured to selectively provide electrical power to the motor controller 112 and to the electric motor 114 (e.g., in response to an ON/OFF switch being activated to an ON position). In general, the swappable battery pack 102 provides electrical power to the electric motor 114 and the electric motor 114 provides rotary power to a plurality of tines 120 that actuate to aerate the ground on which the aerator 100 is traveling. The design and properties of the swappable battery pack 102 and the battery dock connector 116 are described in more detail in PCT/US2023/033002, which is owed by the Applicant and incorporated herein by reference its entirety.

In the illustrated embodiment, the aerator 100 defines a central axis 122 that extends longitudinally along the aerator 100, and the battery mounting bracket 104 is laterally offset from the central axis 122. In other words, no portion of the battery mounting bracket 104 intersects with the central axis 122. In this way, for example, the battery mounting bracket 104 positions the swappable battery pack 102 closer to a lateral side of the aerator 100, which makes installing and removing the swappable battery pack 102 more ergonomic for a user.

The motor mounting bracket 110 arranges the electric motor 114 at an angle relative to the housing surface 108. Specifically, the motor mounting bracket 110 includes a ramped surface 124 on which the electric motor 114 is supported, and the ramped surface 124 defines an angle A between the ramped surface 124 and the housing surface 108. In some embodiments, the angle A is an acute angle. In some embodiments, the angle A is between about 5 degrees and about 40 degrees, or between about 10 degrees and about 30 degrees.

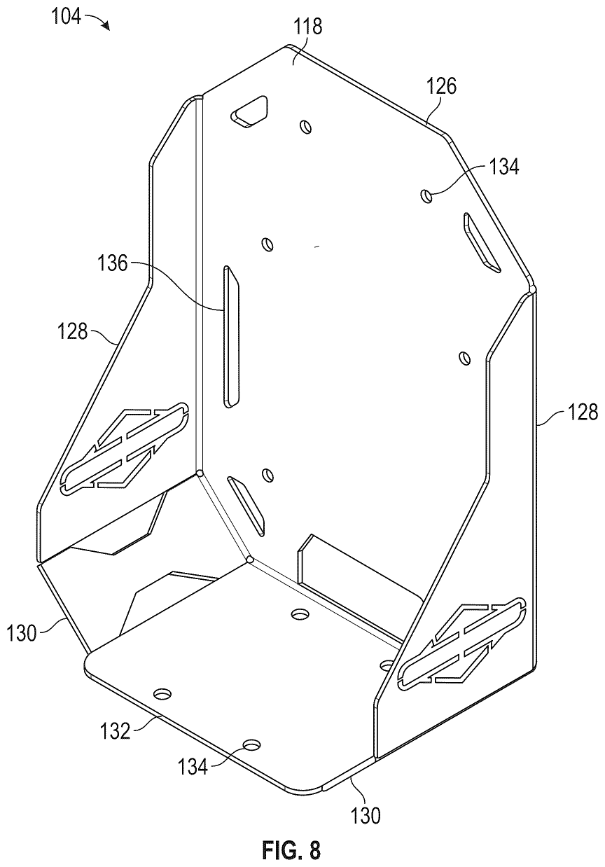

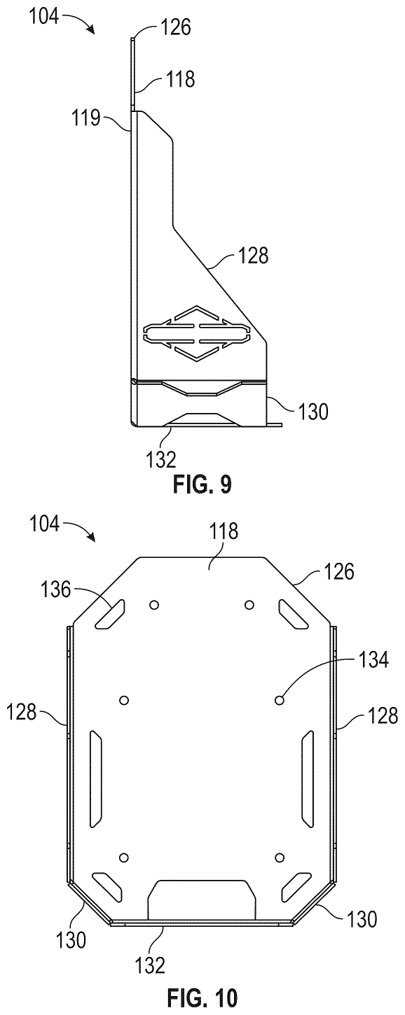

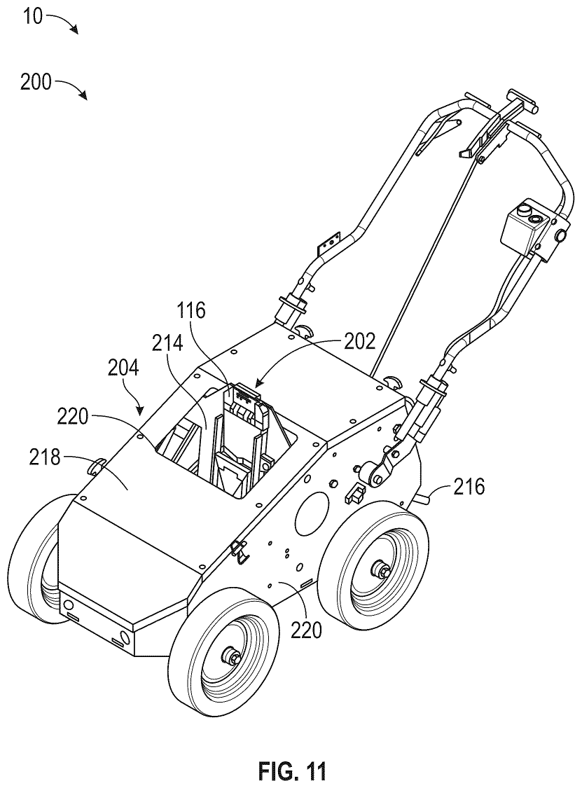

With specific reference to FIGS. 8-10, the battery mounting bracket 104 includes a rear wall 126 having the inner surface 118 and an outer surface 119, a pair of side walls 128, a pair of ramped walls 130, and a base wall 132. In general, the rear wall 126, the side walls 128, the ramped walls 130, and the base wall 132 at least partially enclose the swappable battery pack 102, when the swappable battery pack 102 is installed within the battery mounting bracket 104. The ramped walls 130 extend from laterally opposite sides of the base wall 132. Each of the ramped walls 130 angles laterally outwardly from the base wall 132 (e.g., at an acute angle that is greater than zero degrees and less than ninety degrees) and connects to a respective one of the side walls 128. The side walls 128 extend in a direction generally perpendicular to the base wall 132. Each of the side walls 128, the ramped walls 130, and the base wall 132 is connected to the rear wall 126.

The battery mounting bracket 104 includes one or more mounting apertures 134 that extend through the rear wall 126 and the base wall 132. In general, the mounting apertures 134 formed in the rear wall 126 facilitate coupling the battery dock connector 116 to the battery mounting bracket 104, and the mounting apertures 134 formed in the base wall 132 facilitate coupling the battery mounting bracket 104 to the housing surface 108. The battery mounting bracket 104 includes one or more cooling cutouts or windows 136 that are formed in the rear wall 126, the side walls 128, and/or the ramped walls 130. In general, the cooling cutouts 136 enable airflow through the battery mounting bracket 104 to aid in cooling of the swappable battery pack 102 during operation.

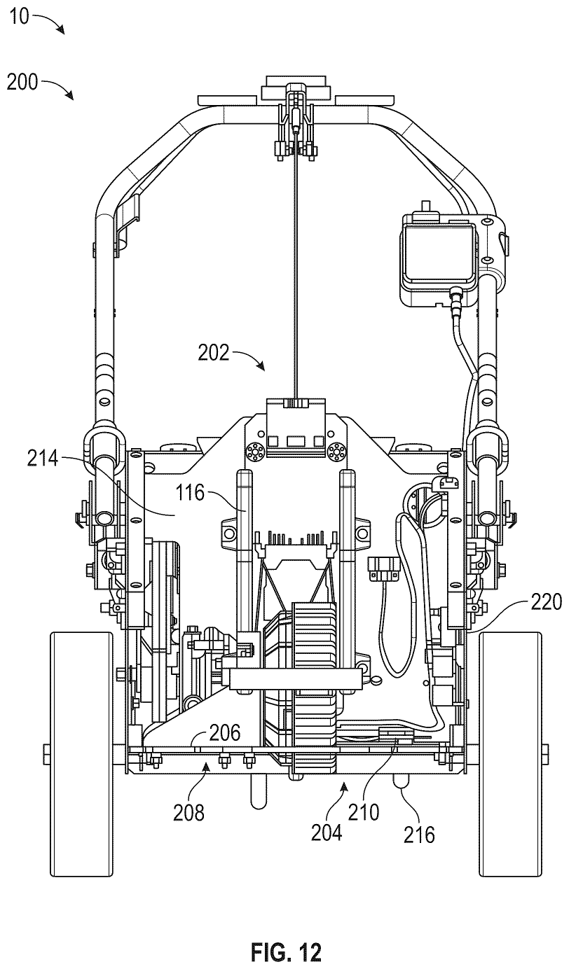

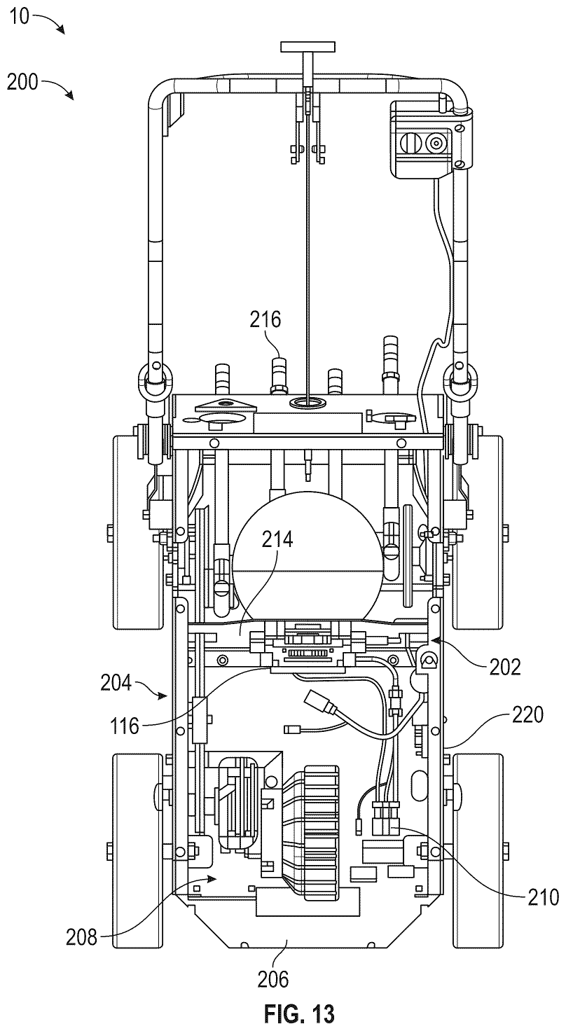

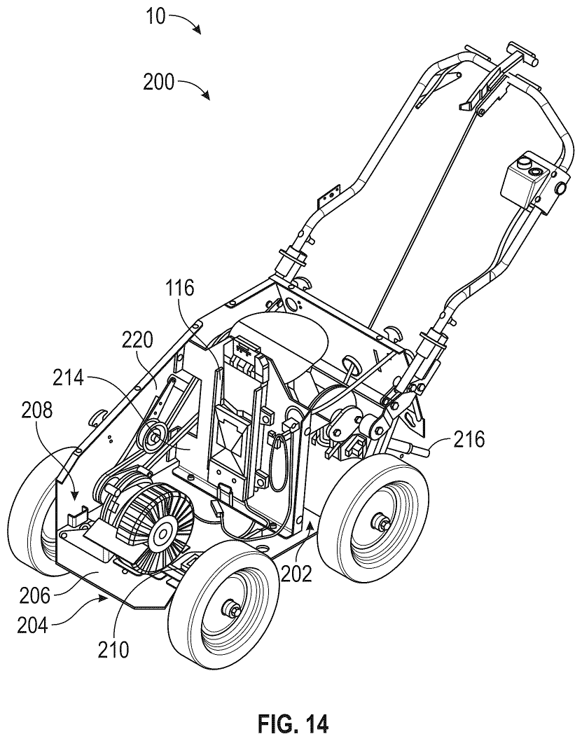

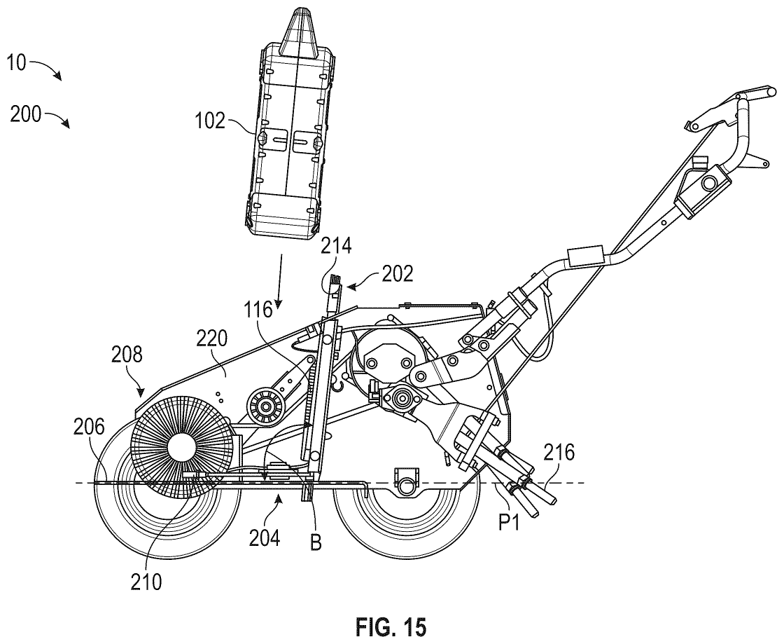

FIGS. 11-15 show the chore product or power equipment 10 in the form of an aerator 200, according to an exemplary embodiment. The aerator 200 is powered by the swappable battery pack 102. The swappable battery pack 102 is received within a battery holder or mounting bracket 202. The battery mounting bracket 202 is coupled to and supported on a body or housing 204 of the aerator 200. Specifically, the housing 204 includes a housing surface 206 (e.g., an inner surface) that supports the battery mounting bracket 202, a motor mounting bracket 208, and a motor controller 210. The motor mounting bracket 208 supports and is coupled to an electric motor or chore motor 212. In the illustrated embodiment, the motor controller 210 is coupled to the housing surface 206. In some embodiments, the motor controller 210 may be coupled to the battery mounting bracket 202 (e.g., to the outer surface 119).

The battery mounting bracket 202 is coupled to the battery dock connector 116. Specifically, the battery dock connector 116 is coupled to a mounting surface 214 of the battery mounting bracket 202. When the swappable battery pack 102 is electrically coupled to and secured by the battery dock connector 116, the swappable battery pack 102 is configured to selectively provide electrical power to the motor controller 210 and to the electric motor 212 (e.g., in response to an ON/OFF switch being activated to an ON position). In general, the swappable battery pack 102 provides electrical power to the electric motor 212 and the electric motor 212 provides rotary power to a plurality of tines 216 that actuate to aerate the ground on which the aerator 200 is traveling.

In the illustrated embodiment, the housing 204 includes a hood or upper wall 218 having a battery cutout 220 through which at least a portion of the battery mounting bracket 202 and the swappable battery pack 102 (when installed on the battery dock connector 116) extend. In the illustrated embodiment, the battery mounting bracket 202 is coupled to the housing surface 206 and to sidewalls 220 of the housing 204. The battery mounting bracket 202 is arranged at an angle B relative to the housing surface 206 or a plane P1 so that the angle B is not a right angle. In other words, the mounting surface 214 of the battery mounting bracket 202 is not perpendicular to the housing surface 206 or the plane P1, and the angle B may be an obtuse angle that is greater than about ninety degrees and less than about one hundred and thirty-five degrees, or between about one hundred degrees and about one hundred and twenty degrees. The plane P1 intersects both of the wheel axes along which the wheels of the aerator 200 rotate.

The angled arrangement of the battery mounting bracket 202 arranges the swappable battery pack 102 at the angle B (e.g., a center axis extending longitudinally along a centerline of a housing of the swappable battery pack 102 is arranged at the angle B), when the swappable battery pack 102 is installed within or removed from the battery mounting bracket 202. And the angled arrangement of the swappable battery pack 102 within the battery mounting bracket 202 makes installing and removing the swappable battery pack 102 (e.g., into and through the battery cutout 220) more ergonomic for a user.

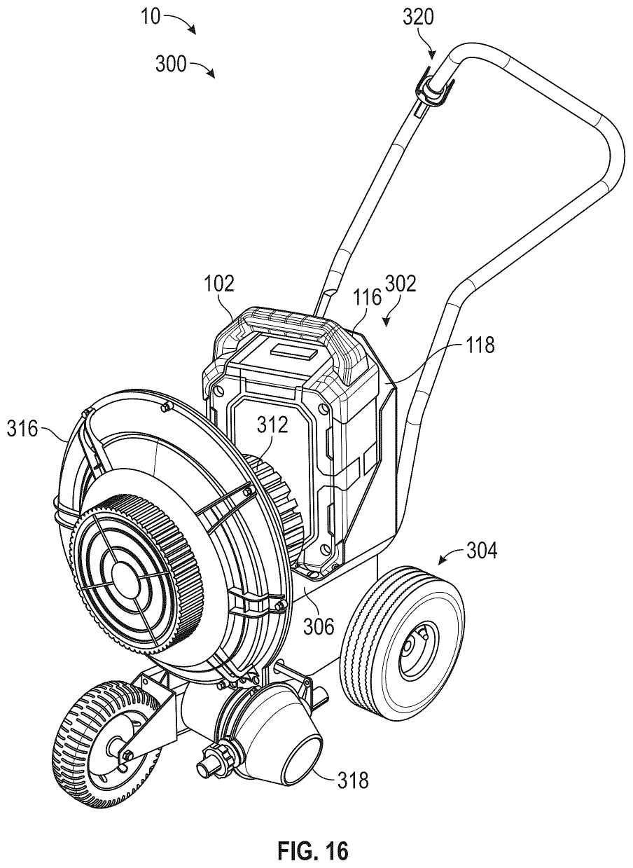

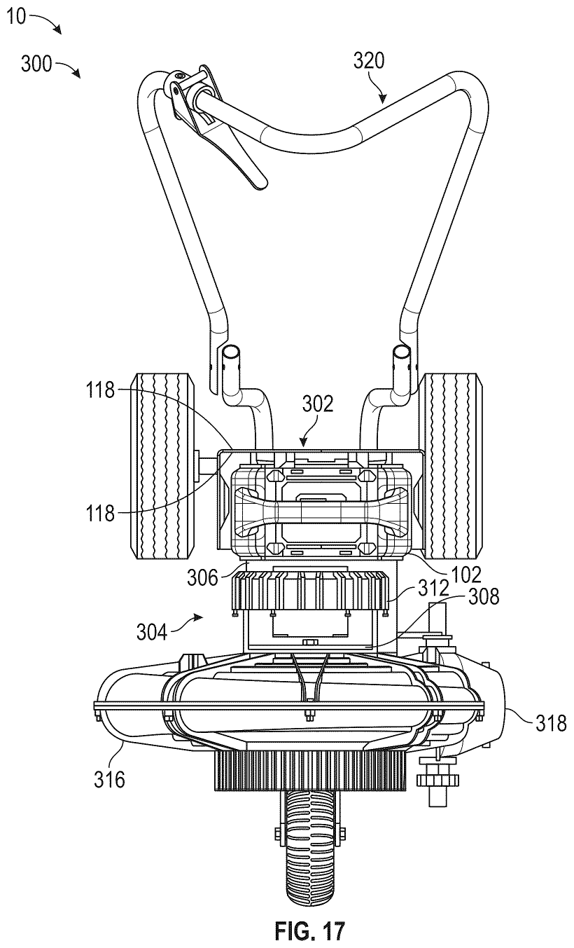

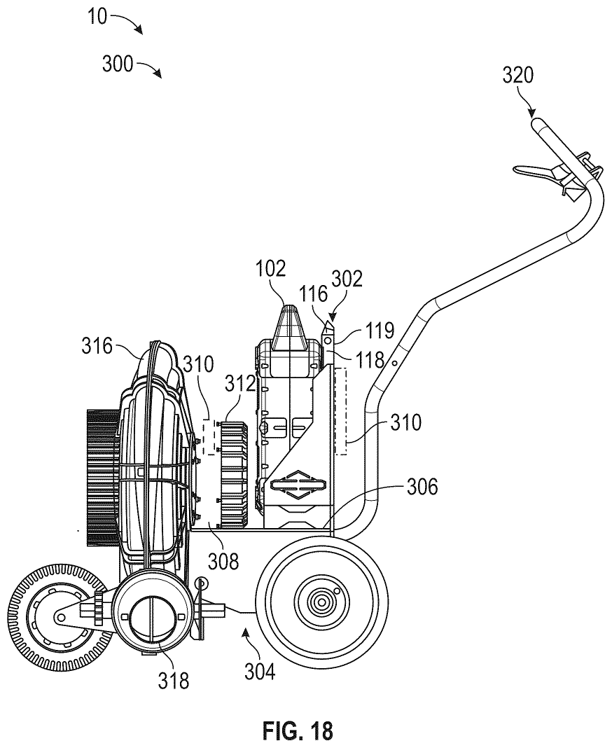

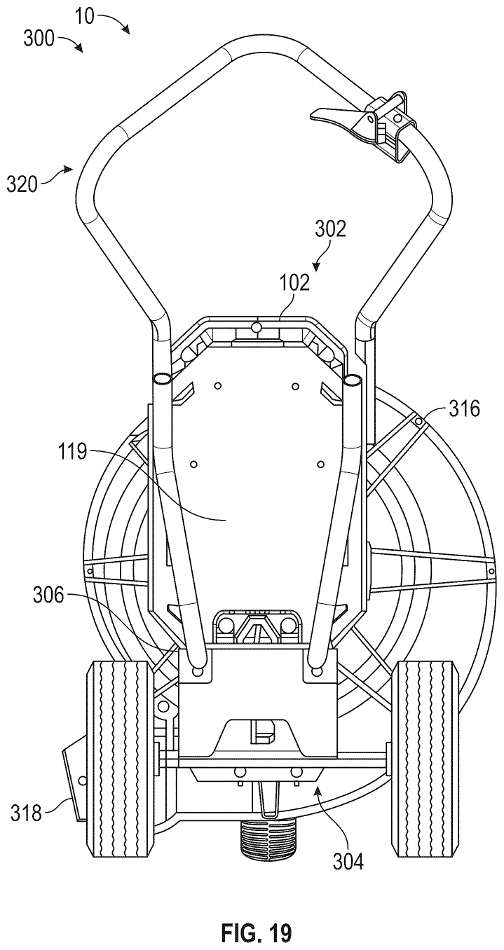

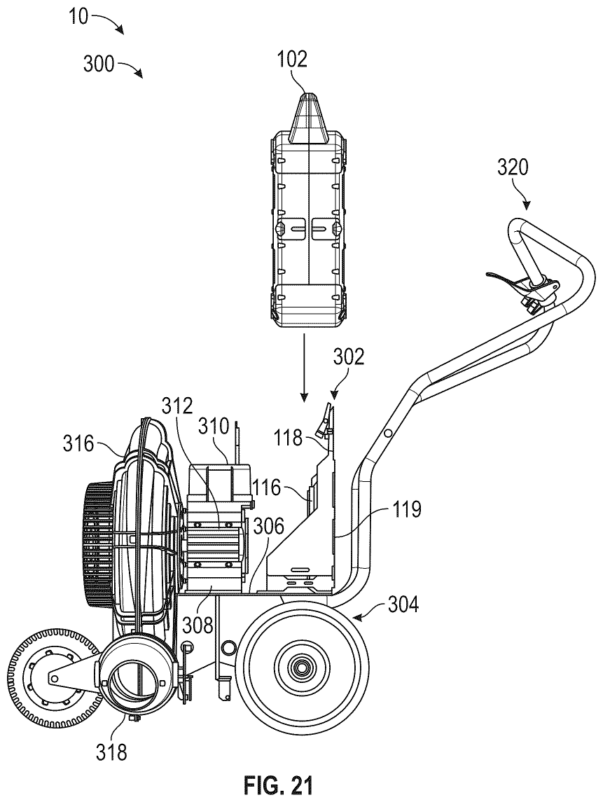

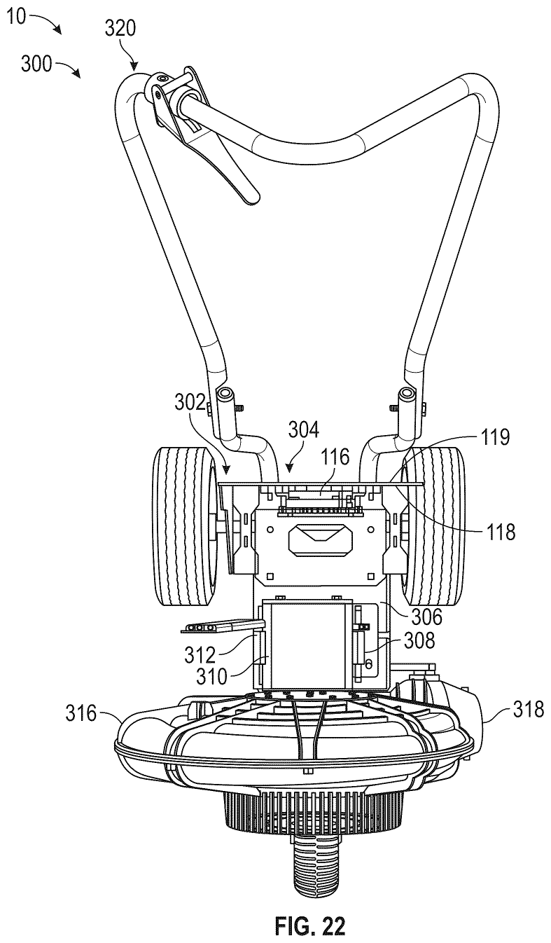

FIGS. 16-22 show the chore product or power equipment 10 in the form of a blower 300, according to an exemplary embodiment. The blower 300 is powered by the swappable battery pack 102. The swappable battery pack 102 is received within a battery holder or mounting bracket 302. The battery mounting bracket 302 is coupled to and supported on a body or housing 304 of the blower 300. Specifically, the housing 304 includes a housing surface 306 (e.g., a top or upper surface) that supports the battery mounting bracket 302, a motor mounting bracket 308, and a motor controller 310. The motor mounting bracket 308 supports and is coupled to an electric motor or chore motor 312. In some embodiments, the motor controller 310 (e.g., shown in dashed lines in FIG. 18) is integrated into the electric motor 312. In some embodiments, the motor controller 310 (e.g., shown in dash-dot-dot-dash lines in FIG. 18) is coupled to and mounted on an outer surface of the battery mounting bracket 302 (e.g., the outer surface 119 of the rear wall 126 that is opposite to the inner surface 118).

In general, the battery mounting bracket 302 may be similar in design and construction as the battery mounting bracket 104, with like features identified using the same reference numerals, except as described herein or otherwise apparent from the figures. The battery mounting bracket 302 is coupled to the battery dock connector 116. Specifically, the battery dock connector 116 is coupled to the inner surface 118 of the battery mounting bracket 302. When the swappable battery pack 102 is electrically coupled to and secured by the battery dock connector 116, the swappable battery pack 102 is configured to selectively provide electrical power to the motor controller 310 and to the electric motor 312 (e.g., in response to an ON/OFF switch being activated to an ON position). In general, the swappable battery pack 102 provides electrical power to the electric motor 312 and the electric motor 312 provides rotary power to a fan 316 that rotates to output airflow through an outlet 318.

In the illustrated embodiment, the battery mounting bracket 302 is arranged between a handlebar assembly 320 and the fan 316, and the electric motor 312 is arranged between the battery mounting bracket 302 and the fan 316.

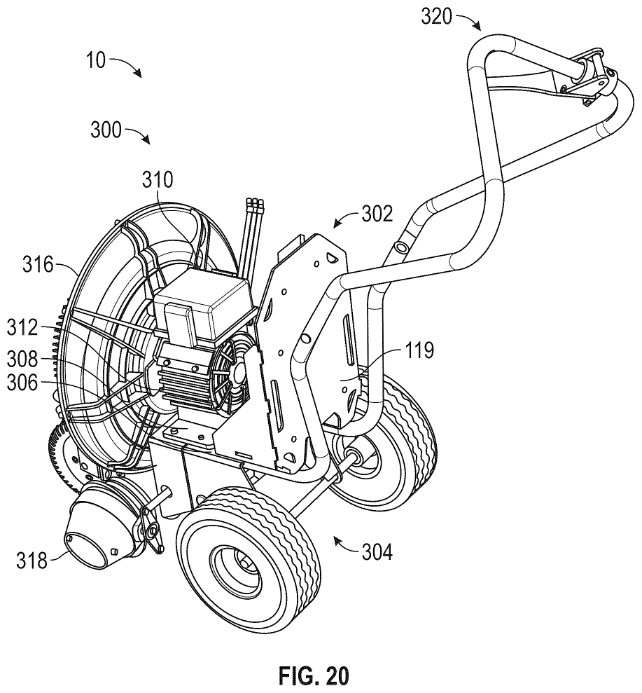

FIGS. 20-22 show an embodiment of the blower 300 with the motor controller 310 being mounted on and coupled to the electric motor 312. Specifically, the motor controller 310 is mounted on a top side of the electric motor 312 (e.g., a side furthest away from a ground on which the blower 300 travels).

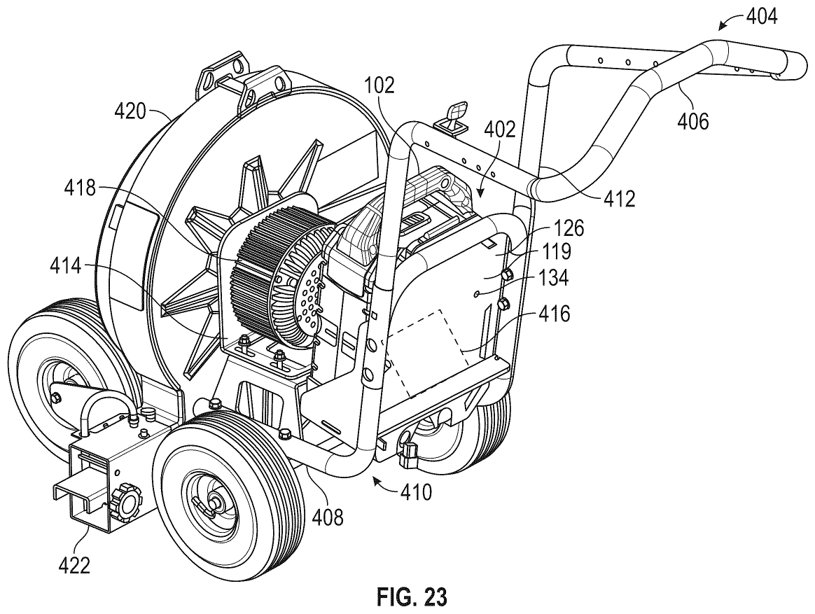

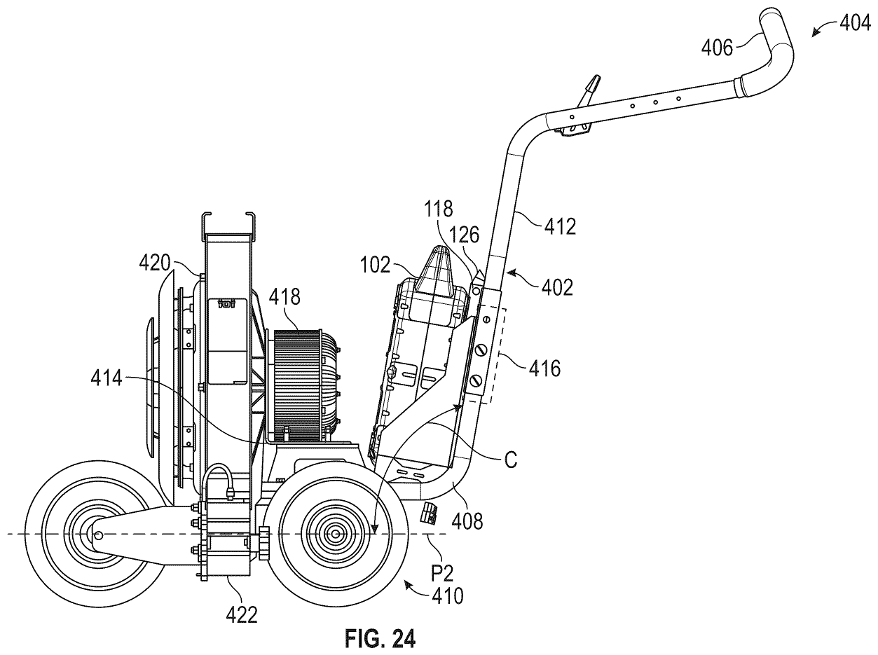

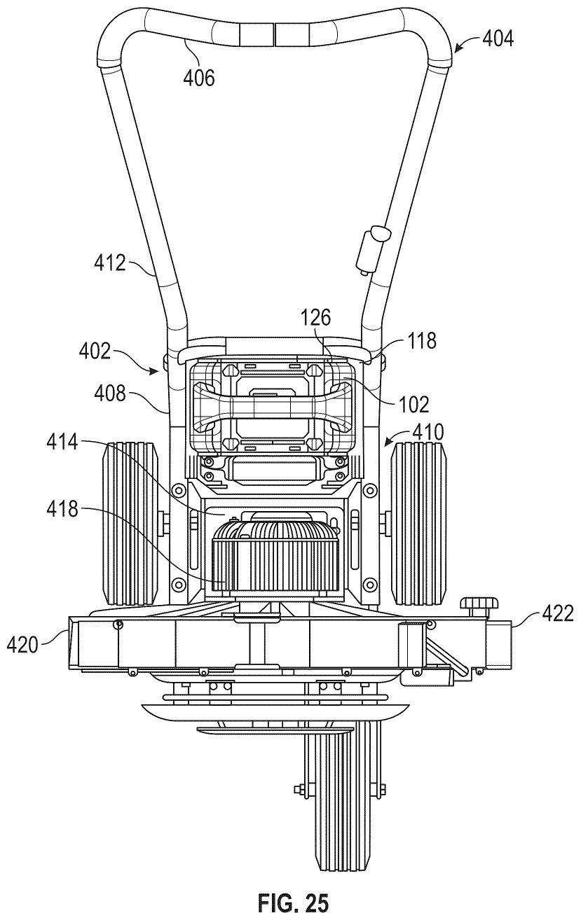

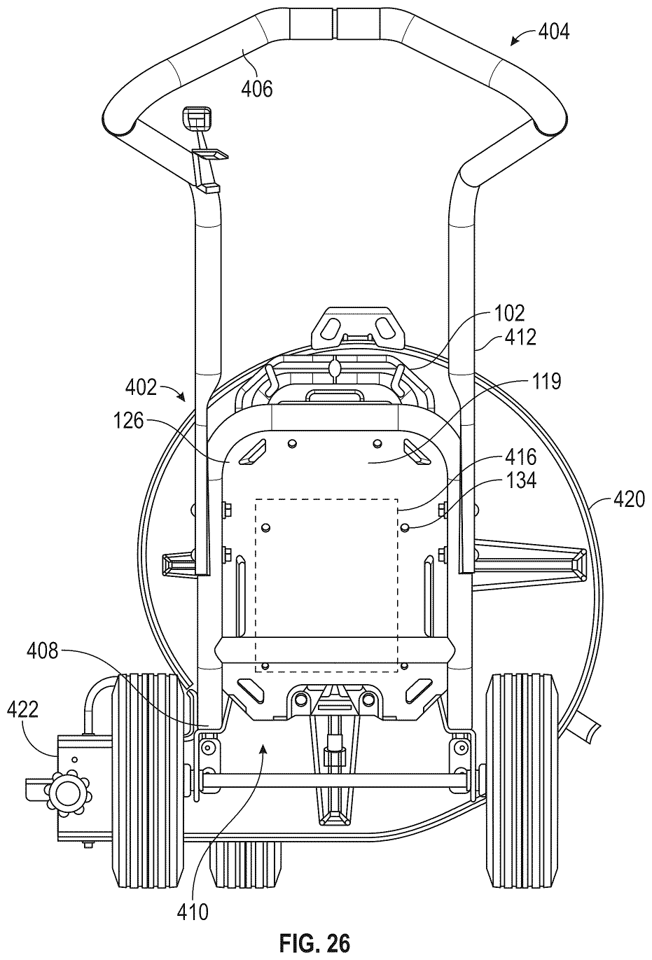

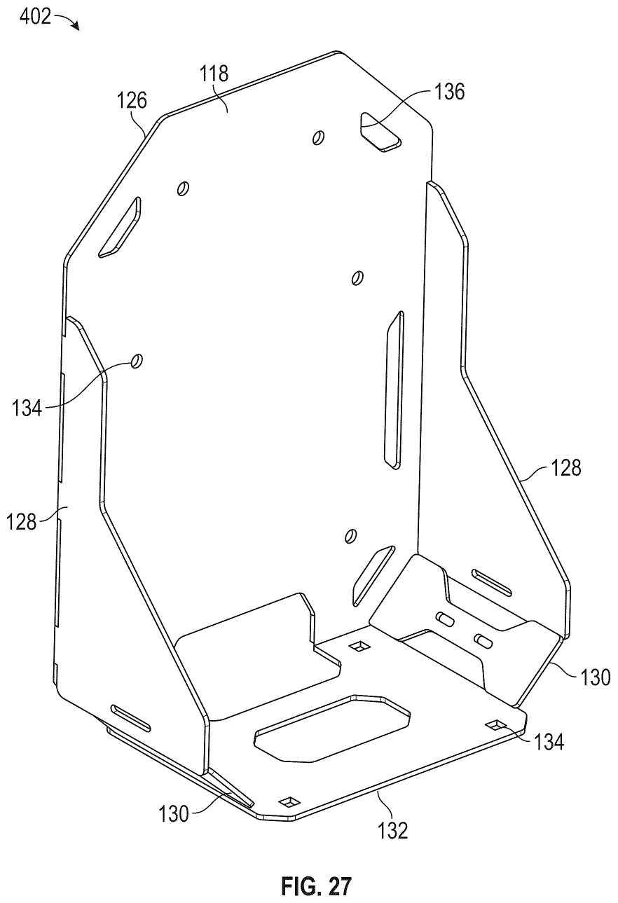

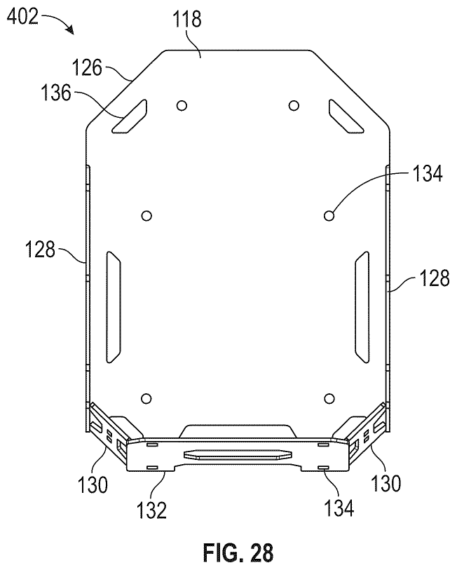

FIGS. 23-28 show the chore product or power equipment 10 in the form of a blower 400, according to an exemplary embodiment. The blower 400 is powered by the swappable battery pack 102. The swappable battery pack 102 is received within a battery holder or mounting bracket 402. The battery mounting bracket 402 is coupled to and supported on a handlebar assembly 404 of the blower 400. Specifically, the handlebar assembly 404 includes an upper portion 406 where a user is intended to grip the handlebar assembly 404, a lower portion 408 where the handlebar assembly 404 couples to a housing or body 410 of the blower 400, and an intermediate portion 412 arranged between the upper portion 406 and the lower portion 408. The battery mounting bracket 402 is arranged at a junction between the lower portion 408 and the intermediate portion 412, and extends laterally between rods or bars that extend along the intermediate portion 412.

The housing 410 supports a motor mounting bracket 414 and a motor controller 416. The motor mounting bracket 414 supports and is coupled to an electric motor or chore motor 418. In the illustrated embodiment, the motor controller 416 (e.g., shown in dashed lines in FIGS. 23, 24, and 26) is coupled to and mounted on the outer surface 119 of the battery mounting bracket 402 (e.g., the outer surface 119 of the rear wall 126 that is opposite to the inner surface 118). The motor controller 416 may be enclosed or covered on the outer surface 119 by a motor controller cover. The motor controller cover may include one or more cover apertures that each align with a respective one of the mounting apertures 134 formed in the rear wall 126 to facilitate the motor controller cover being coupled to the battery mounting bracket 402 (e.g., using a fastener that extends through aligned pairs of the mounting apertures 134 and the cover apertures 419).

In general, the battery mounting bracket 402 may be similar in design and construction as the battery mounting bracket 104, with like features identified using the same reference numerals, except as described herein or otherwise apparent from the figures. The battery mounting bracket 402 is coupled to the battery dock connector 116. Specifically, the battery dock connector 116 is coupled to the inner surface 118 of the battery mounting bracket 402. When the swappable battery pack 102 is electrically coupled to and secured by the battery dock connector 116, the swappable battery pack 102 is configured to selectively provide electrical power to the motor controller 416 and to the electric motor 418 (e.g., in response to an ON/OFF switch being activated to an ON position). In general, the swappable battery pack 102 provides electrical power to the electric motor 418 and the electric motor 418 provides rotary power to a fan 420 that rotates to output airflow through an outlet 422.

In the illustrated embodiment, the battery mounting bracket 402 is arranged between the handlebar assembly 404 and the fan 420, and the electric motor 418 is arranged between the battery mounting bracket 402 and the fan 420. In the illustrated embodiment, the battery mounting bracket 402 is coupled to the handlebar assembly 404 so that the battery mounting bracket 402 is arranged at an angle C relative to a plane P2 so that the angle B is not a right angle. In other words, the inner surface 118 of the battery mounting bracket 402 is not perpendicular to the plane P2, and the angle C may be an obtuse angle that is greater than about ninety degrees and less than about one hundred and thirty-five degrees, or between about one hundred degrees and about one hundred and twenty degrees. The plane P1 intersects both of the wheel axes along which the wheels of the blower 400 rotate.

The angled arrangement of the battery mounting bracket 402 arranges the swappable battery pack 102 at the angle C (e.g., a center axis extending longitudinally along a centerline of a housing of the swappable battery pack 102 is arranged at the angle C), when the swappable battery pack 102 is installed within or removed from the battery mounting bracket 402. And the angled arrangement of the swappable battery pack 102 within the battery mounting bracket 402 makes installing and removing the swappable battery pack 102 more ergonomic for a user.

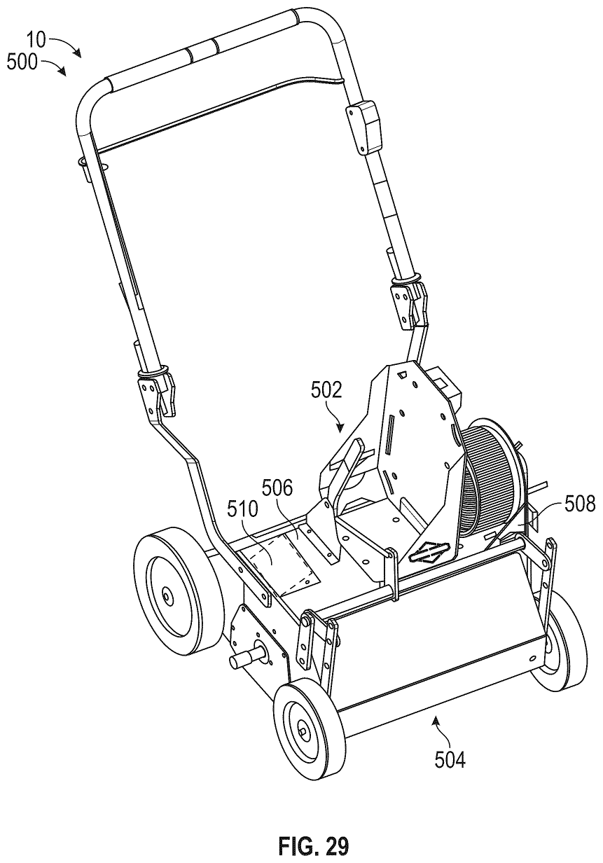

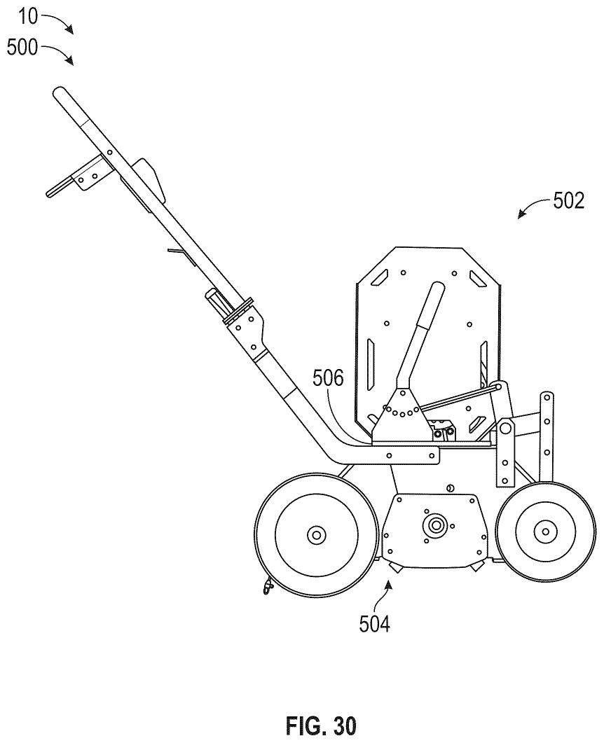

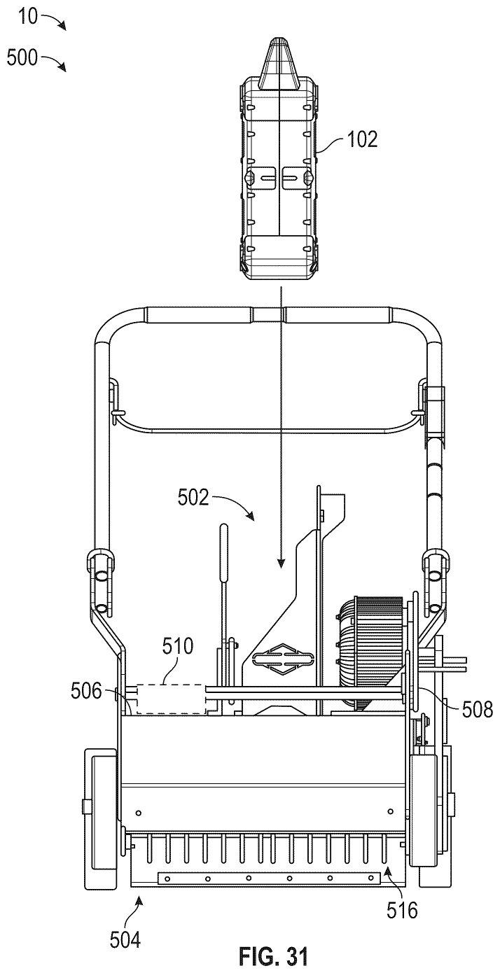

FIGS. 29-31 show the chore product or power equipment 10 in the form of a power rake or turf rake 500, according to an exemplary embodiment. The turf rake 500 is powered by the swappable battery pack 102. The swappable battery pack 102 is received within a battery holder or mounting bracket 502. The battery mounting bracket 502 is coupled to and supported on a body or housing 504 of the turf rake 500. Specifically, the housing 504 includes a housing surface 506 (e.g., a top or upper surface) that supports the battery mounting bracket 502, a motor mounting bracket 508, and a motor controller 510. The motor mounting bracket 508 supports and is coupled to an electric motor or chore motor 512. In some embodiments, the motor controller 510 may be integrated into the electric motor 512. In some embodiments, the motor controller 510 is supported on and coupled to the housing surface 506 (e.g., shown in dashed lines in FIGS. 29 and 31). In some embodiments, the motor controller may be coupled to the outer surface 119 of the battery mounting bracket 502.

In general, the battery mounting bracket 502 may be similar in design and construction as the battery mounting bracket 104, with like features identified using the same reference numerals, except as described herein or otherwise apparent from the figures. The battery mounting bracket 502 is coupled to the battery dock connector 116. Specifically, the battery dock connector 116 is coupled to the inner surface 118 of the battery mounting bracket 302. When the swappable battery pack 102 is electrically coupled to and secured by the battery dock connector 116, the swappable battery pack 102 is configured to selectively provide electrical power to the motor controller 510 and to the electric motor 512 (e.g., in response to an ON/OFF switch being activated to an ON position). In general, the swappable battery pack 102 provides electrical power to the electric motor 512 and the electric motor 512 provides rotary power to one or more blade or rake assemblies 516 that rotate to rake a ground on which the turf rake 500 travels.

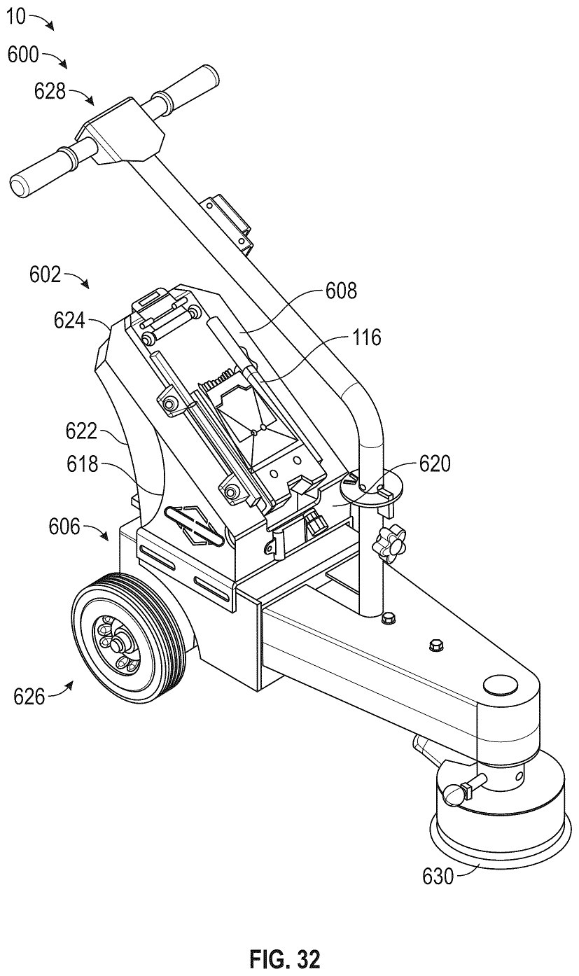

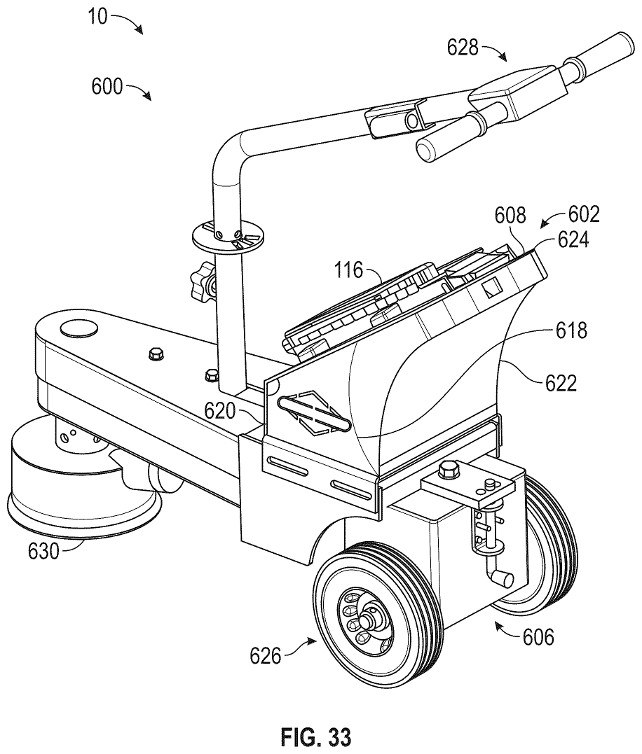

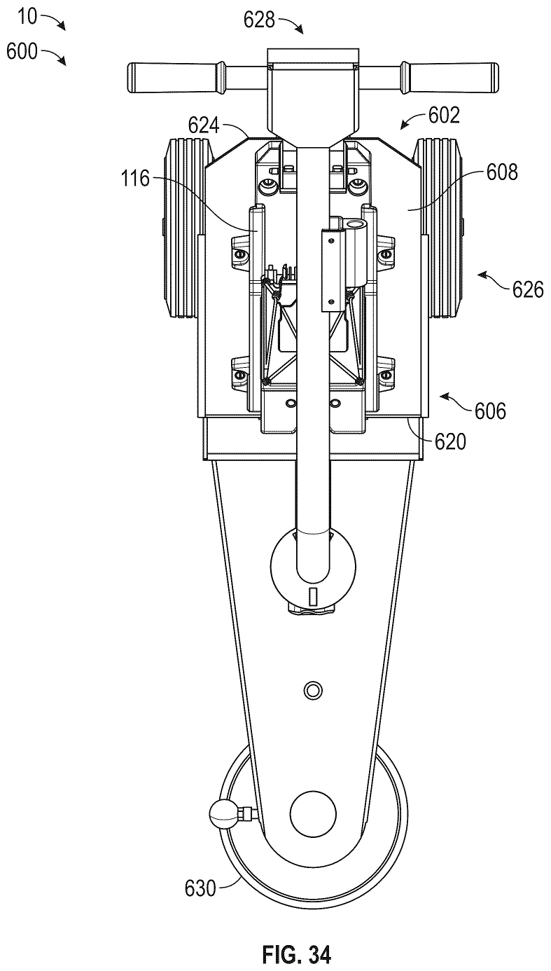

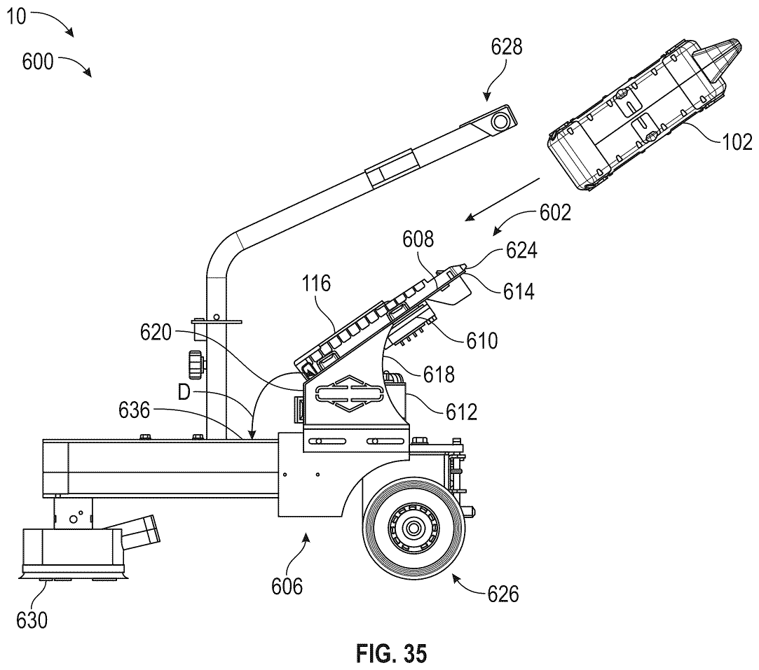

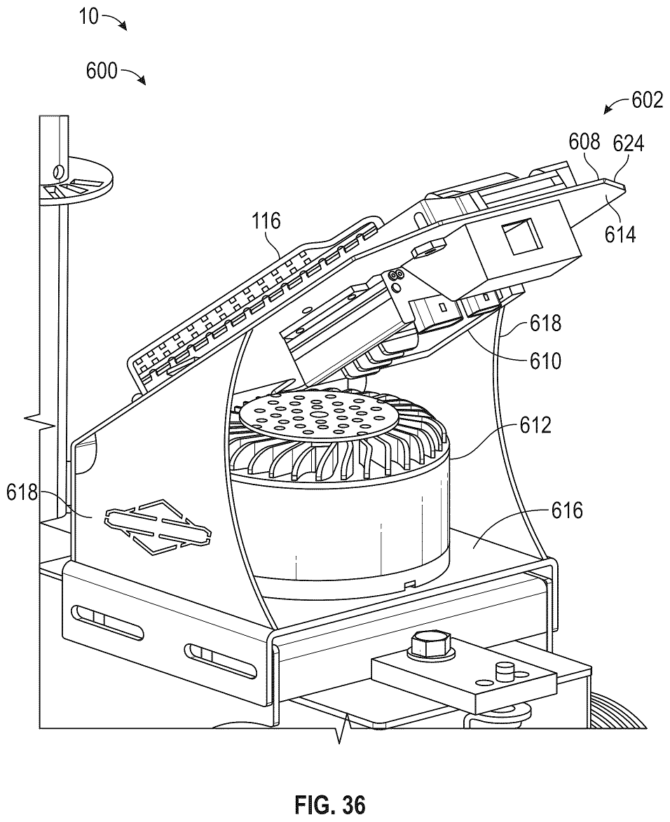

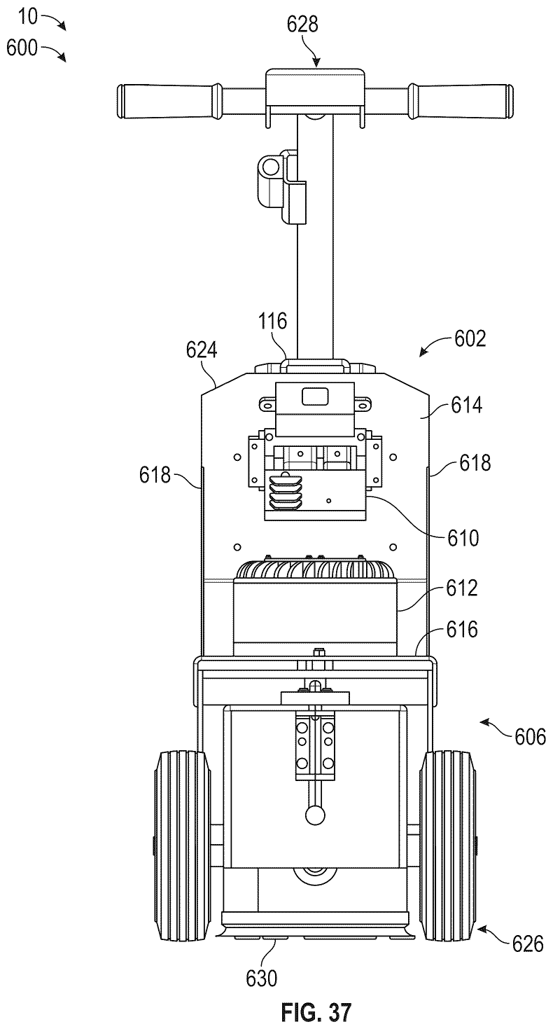

FIGS. 32-37 show the chore product or power equipment 10 in the form of an edge grinder 600, according to an exemplary embodiment. The edge grinder 600 is powered by the swappable battery pack 102. The swappable battery pack 102 is received within a battery holder or mounting bracket 602. The battery mounting bracket 602 is integrated into or arranged on a motor housing or enclosure 604 that is coupled to and supported on a body or housing 606 of the edge grinder 600. Specifically, an outer surface 608 (e.g., a top or upper surface) of the motor housing 604 forms the battery mounting bracket 602. A motor controller 610 and an electric motor or chore motor 612 are at least partially enclosed within the motor housing 604. In the illustrated embodiment, the motor controller 610 is coupled to an inner surface 614 of the motor housing 604 (e.g., an inner surface that is arranged opposite to the outer surface 608).

The motor housing 604 includes a bottom wall 616, a pair of side walls 618, a front wall 620, a rear wall 622, and a top wall 624 having the outer surface 608 and the inner surface 614. The bottom wall 616, the side walls 618, the front wall 620, the rear wall 622, and the top wall 624 combine to form an enclosure that encloses the motor controller 610 and at least partially encloses the electric motor 612 (e.g., a drive shaft may extend out of the motor housing 604). In the illustrated embodiment, the motor housing 604 is coupled to the housing 606 in a location that is generally between a pair of rear wheels 626 and a handlebar assembly 628, which arranges the swappable battery pack 102 between the rear wheels 626 and the handlebar assembly 628.

The battery dock connector 116 is coupled to the outer surface 608. When the swappable battery pack 102 is electrically coupled to and secured by the battery dock connector 116, the swappable battery pack 102 is configured to selectively provide electrical power to the motor controller 610 and to the electric motor 612 (e.g., in response to an ON/OFF switch being activated to an ON position). In general, the swappable battery pack 102 provides electrical power to the electric motor 612 and the electric motor 612 provides rotary power to a grinder 630 that rotates to grind a material under the grinder 630.

In the illustrated embodiment, the outer surface 608 (e.g., the battery mounting bracket 602) is arranged at an angle D relative to a housing surface 636 of the housing 606 (e.g., the surface on which the motor housing 604 is supported) so that the angle D is not a right angle. In other words, the outer surface 608 is not perpendicular to the housing surface 636, and the angle D may be an obtuse angle that is greater than about ninety degrees and less than about one hundred and sixty degrees, or between about one hundred degrees and about one hundred and fifty degrees.

The angled arrangement of the battery mounting bracket 602 arranges the swappable battery pack 102 at the angle D (e.g., a center axis extending longitudinally along a centerline of a housing of the swappable battery pack 102 is arranged at the angle D), when the swappable battery pack 102 is installed on or removed from the battery mounting bracket 602. And the angled arrangement of the swappable battery pack 102 on the battery mounting bracket 602 makes installing and removing the swappable battery pack 102 more ergonomic for a user.

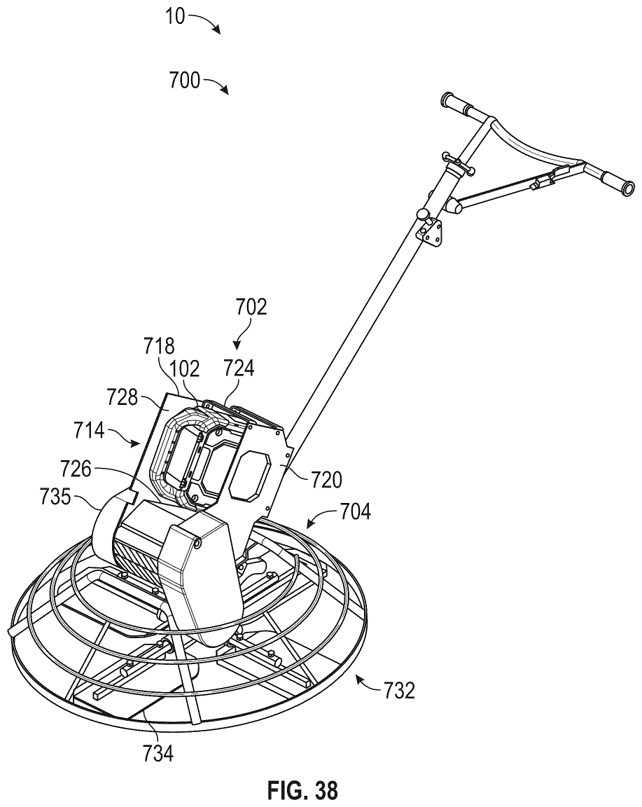

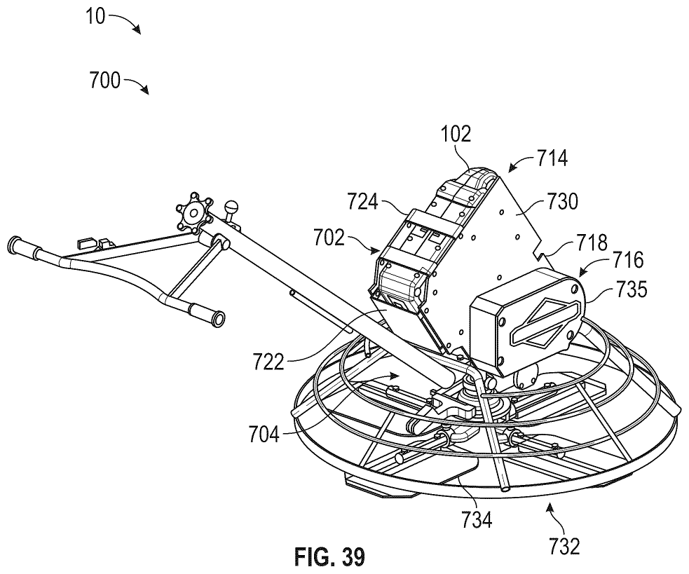

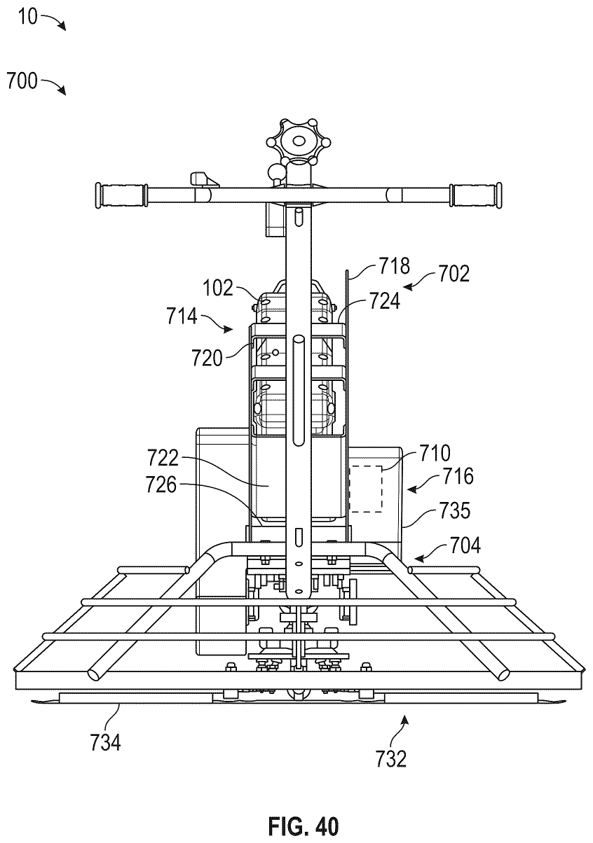

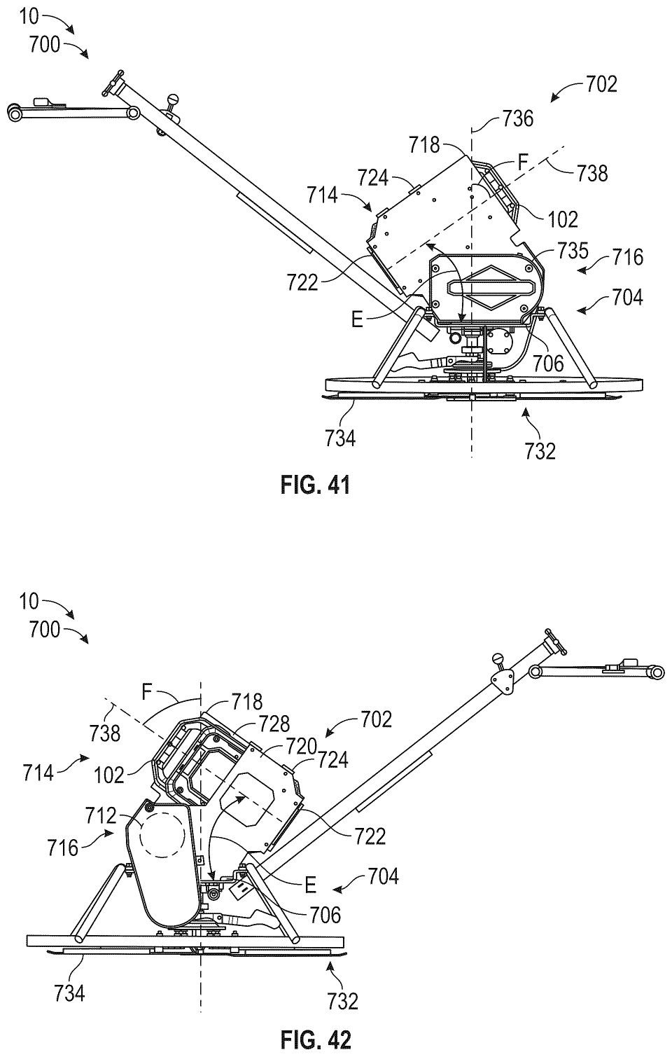

FIGS. 38-42 show the chore product or power equipment 10 in the form of a trowel 700 (e.g., a walk-behind trowel), according to an exemplary embodiment. The trowel 700 is powered by the swappable battery pack 102. The swappable battery pack 102 is received within a battery holder or housing 702. The battery housing 702 is supported on and coupled to a mounting plate 704 of the trowel 700. Specifically, the battery housing 702 is coupled to an upper surface 706 of the mounting plate 704. In general, the battery housing 702 at least partially supports and/or at least partially encloses/houses a motor controller 710 and an electric motor or chore motor 712.

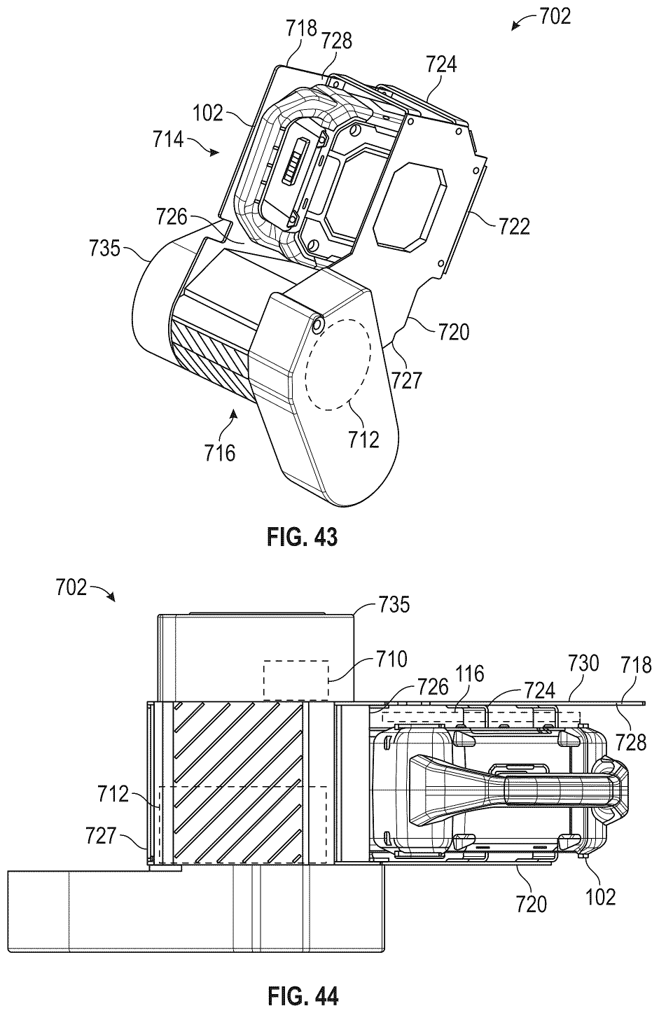

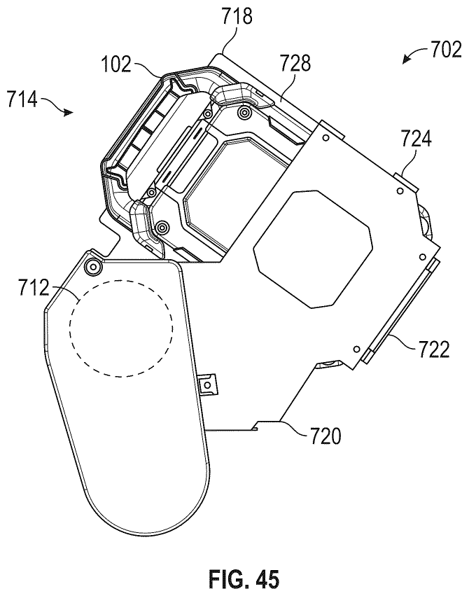

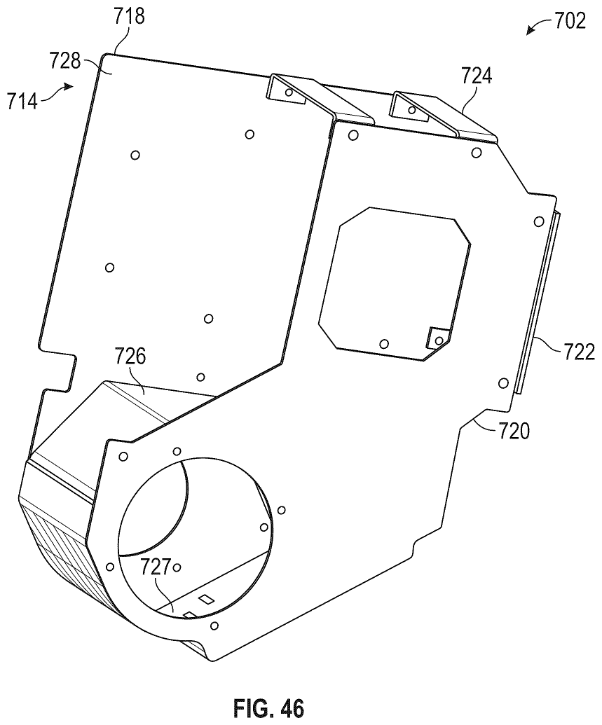

With reference to FIGS. 43-46, the battery housing 702 includes an upper portion 714 and a lower portion 716. In general, the upper portion 714 receives the swappable battery pack 102 and the lower portion receives the electric motor 712. The upper portion includes a first side wall 718, a second side wall 720 that is laterally spaced from the first side wall 718, a base wall 722, one or more upper brackets 724 extending between the first side wall 718 and the second side wall 720, an intermediate wall 726 arranged between the swappable battery pack 102 and the electric motor 712 (e.g., separating the upper portion 714 and the lower portion 716), and a lower wall 727. In general, the first side wall 718, the second side wall 720, the base wall 722, and the intermediate wall 726 form a cavity within which the swappable battery pack 102 is least partially received. The first side wall 718, the second side wall 720, the intermediate wall 726, and the lower wall 727 at least partially enclose the electric motor 712.

The first side wall 718 includes an inner surface 728 and an outer surface 730. The battery dock connector 116 is coupled to the inner surface 728. When the swappable battery pack 102 is electrically coupled to and secured by the battery dock connector 116, the swappable battery pack 102 is configured to selectively provide electrical power to the motor controller 710 and to the electric motor 712 (e.g., in response to an ON/OFF switch being activated to an ON position). In general, the swappable battery pack 102 provides electrical power to the electric motor 712 and the electric motor 712 provides rotary power to a trowel assembly 732 having one or more trowel blades 734 that rotates to smooth a material under the trowel assembly 732 (e.g., concrete).

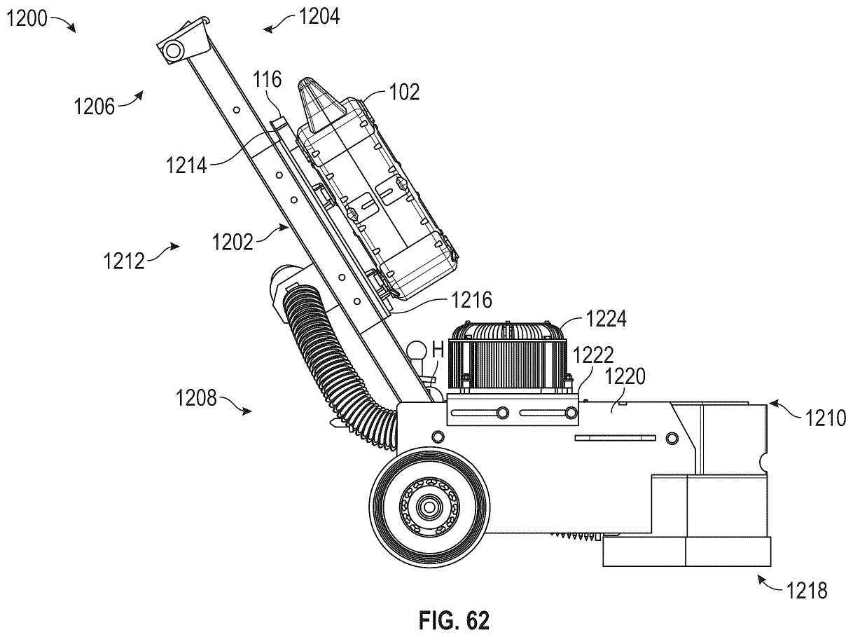

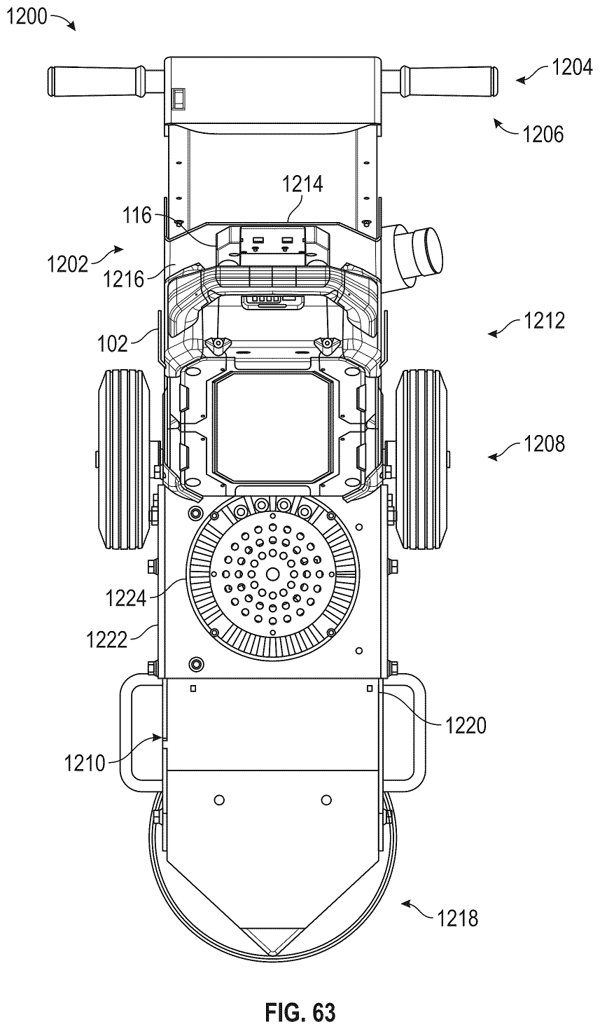

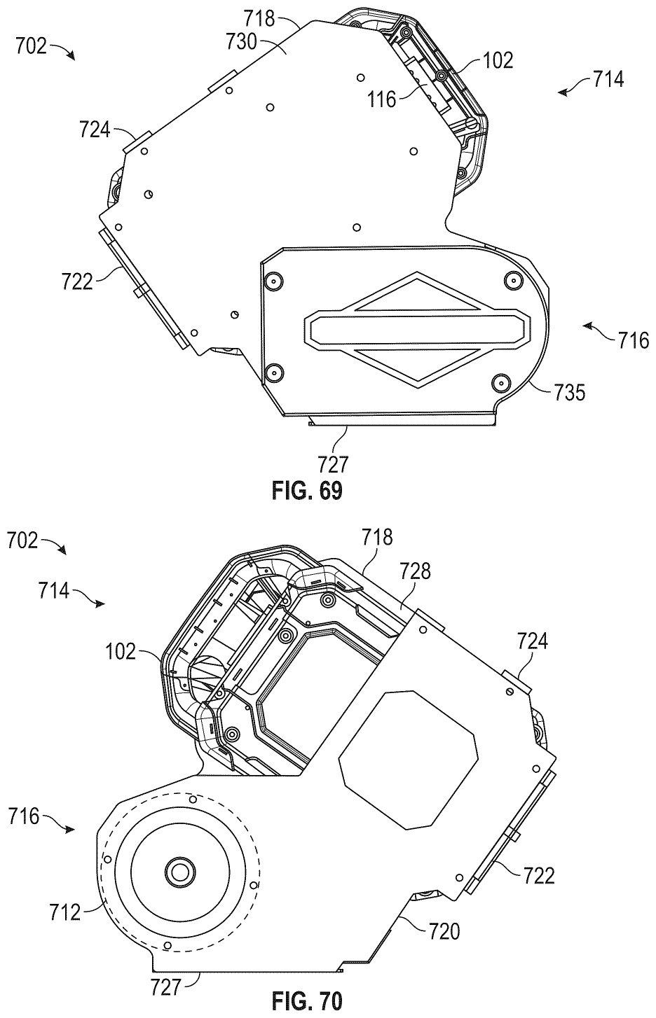

In the illustrated embodiment, the motor controller 710 (e.g., shown in dashed lines in FIGS. 62-64 and 69-70) is coupled to the outer surface 730 of the first side wall 718. Specifically, the motor controller 710 is coupled to the first side wall 718 and enclosed within a motor controller housing 735 that is also coupled to the first side wall 718. In this way, for example, the battery housing 702 may act as a universal housing that facilitates supporting each of the swappable battery pack 102, the motor controller 710, and the electric motor 712.

In the illustrated embodiment, the battery housing 702 arranges the swappable battery pack 102 at an angle relative to the mounting plate 704 and a rotational axis 736 defined by the trowel assembly 732 (e.g., an axis about which the blades 734 rotate). In the illustrated embodiment, the base wall 722 is arranged at an angle relative to the upper surface 706 of the mounting plate 704 so that an axis 738 extending normal to the base wall 722 and along a centerline of the swappable battery pack 102 defines an angle E between the upper surface 706 and the axis 738. In the illustrated embodiment, the angle E is not a right angle and the base wall 722 is not perpendicular to the upper surface 706. In some embodiments, the angle E may be an acute angle that is greater than about zero degrees and less than about ninety degrees, or greater than about ten degrees and less than about eighty degrees, or between about twenty degrees and about seventy degrees. The angled orientation of the base wall 722 also defines an angle F between the rotational axis 736 and the axis 738. In some embodiments, the angle F is about equal to ninety degrees minus the angle E. In some embodiments, the angle F may be an acute angle that is greater than about zero degrees and less than about ninety degrees, or greater than about ten degrees and less than about eighty degrees, or between about twenty degrees and about seventy degrees.

The angled arrangement of the base wall 722 arranges the swappable battery pack 102 at the angle E or the angle F, when the swappable battery pack 102 is installed within or removed from the battery housing 702. And the angled arrangement of the swappable battery pack 102 within the battery housing 702 makes installing and removing the swappable battery pack 102 more ergonomic for a user.

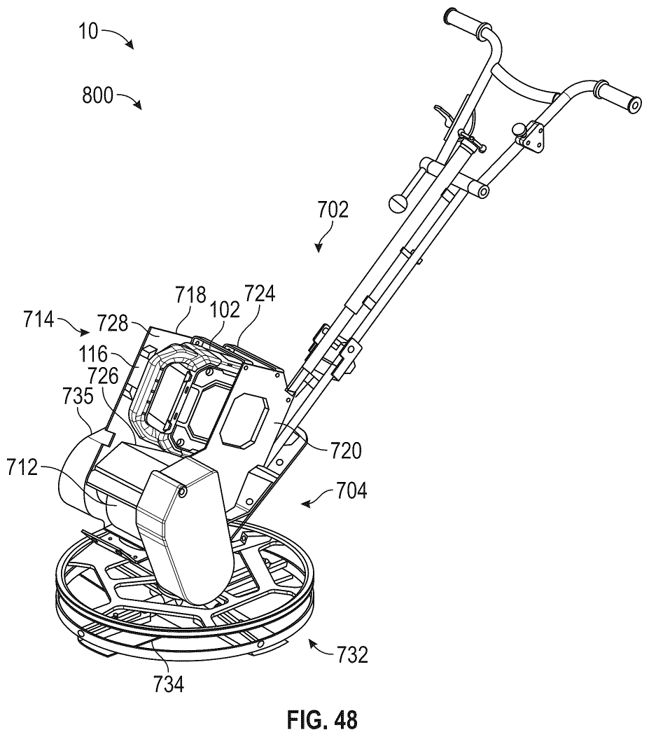

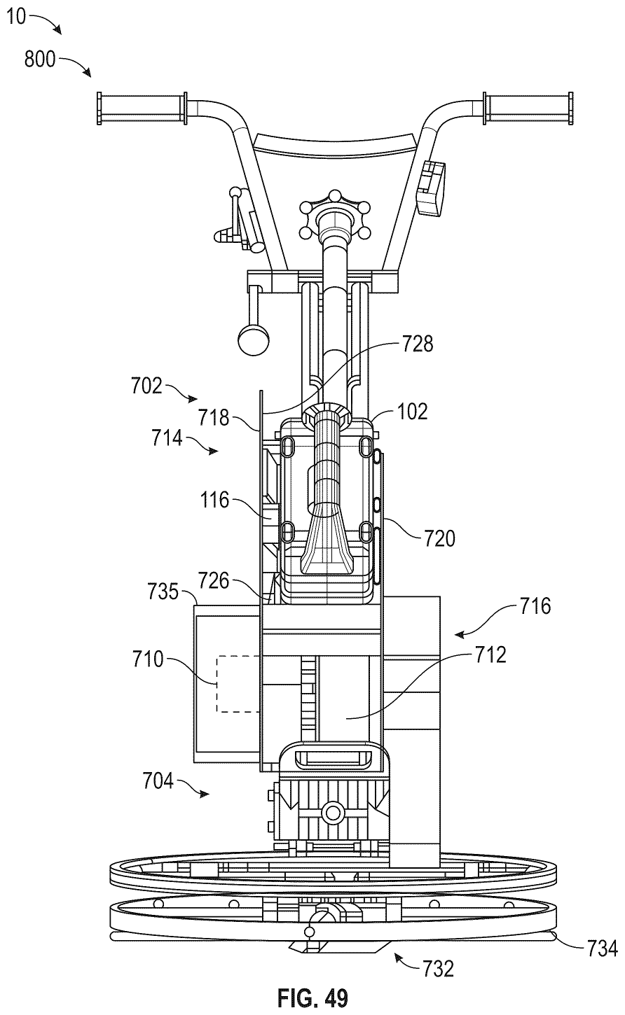

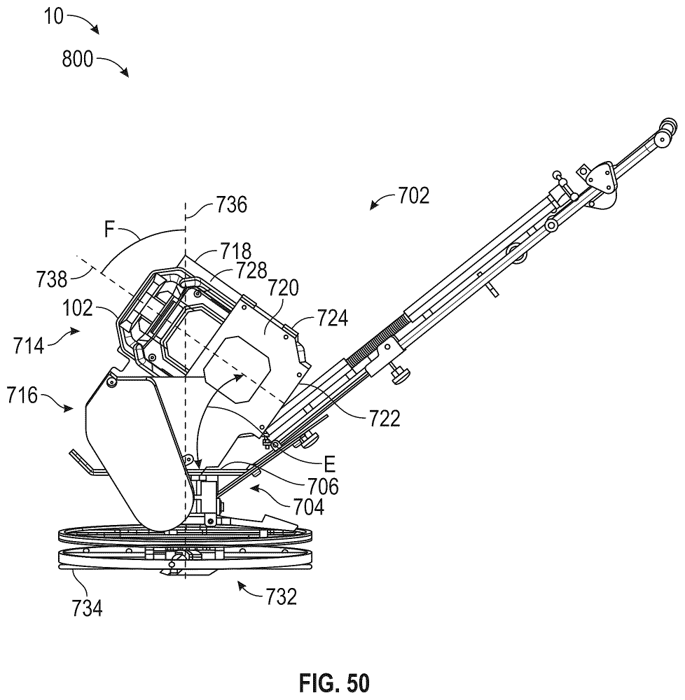

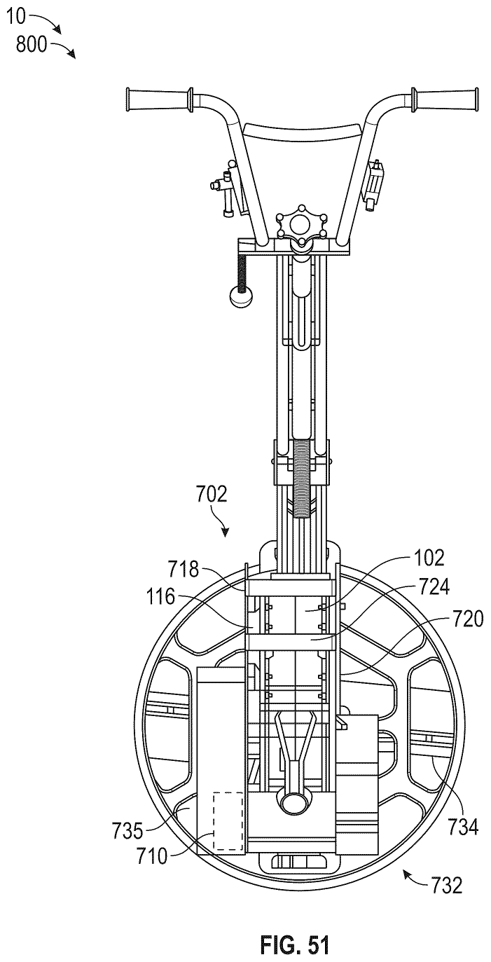

FIGS. 48-51 show the chore product or power equipment 10 in the form of a trowel 800 (e.g., a walk-behind trowel), according to an exemplary embodiment. In general, the trowel 800 is similar to the trowel 700, with like components identified using the same reference numerals, except as described herein or as apparent from the figures. The trowel 800 is a different model than the trowel 700, but the battery housing 702 is implemented to couple the swappable battery pack 102, the motor controller 710, and the electric motor 712 to the trowel 800. It should be appreciated that the type of motor controller or the power rating of the electric motor may vary from trowel model to trowel model, but the design and properties of remains the same the battery housing 702. In this way, for example, the battery housing 702 may act as a retrofit kit that is used to mount the electrical components (i.e., the swappable battery pack 102, the motor controller 710, and the electric motor 712) to a piece of power equipment that was previously or conventionally powered by an ICE.

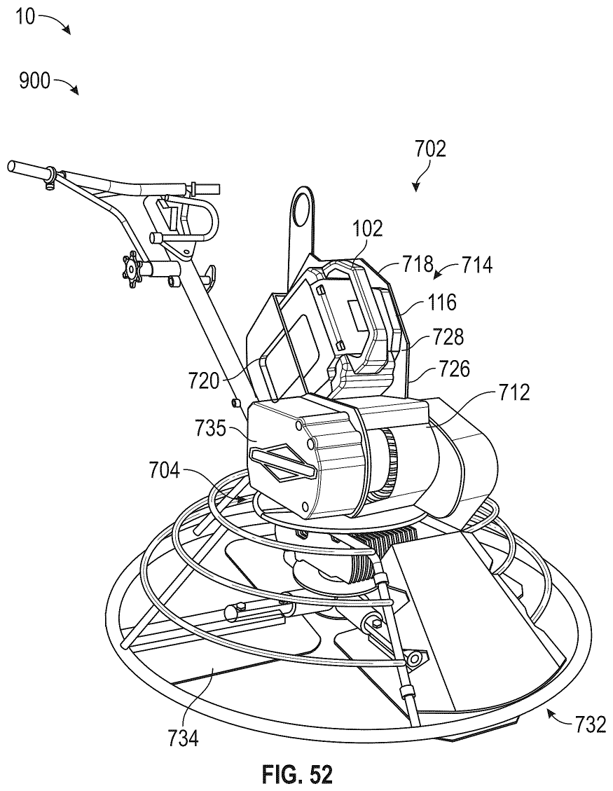

FIG. 52 shows the chore product or power equipment 10 in the form of a trowel 900 (e.g., a walk-behind trowel), according to an exemplary embodiment. In general, the trowel 900 is similar to the trowel 700, with like components identifies using the same reference numerals, except as described herein or as apparent from the figures. The trowel 900 is a different model than the trowel 700, but the battery housing 702 is implemented to couple the swappable battery pack 102, the motor controller 710, and the electric motor 712 to the trowel 900.

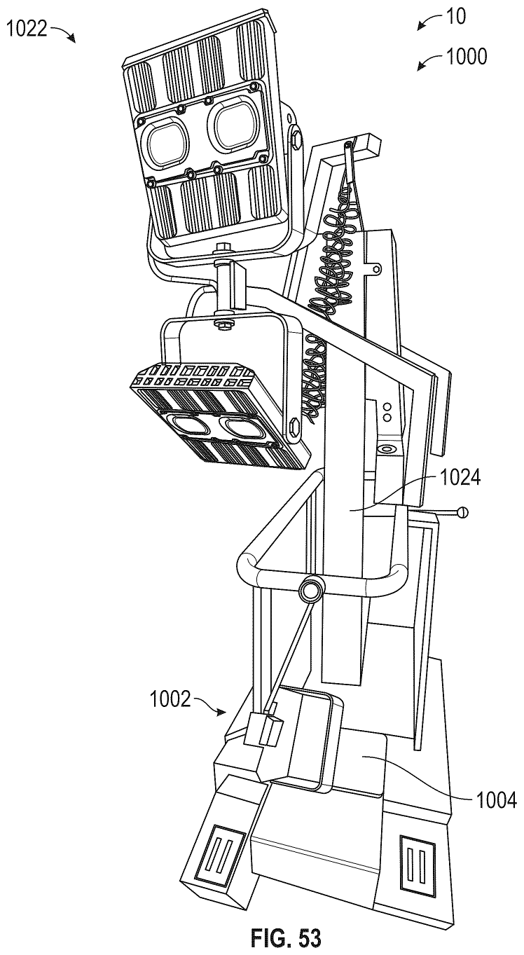

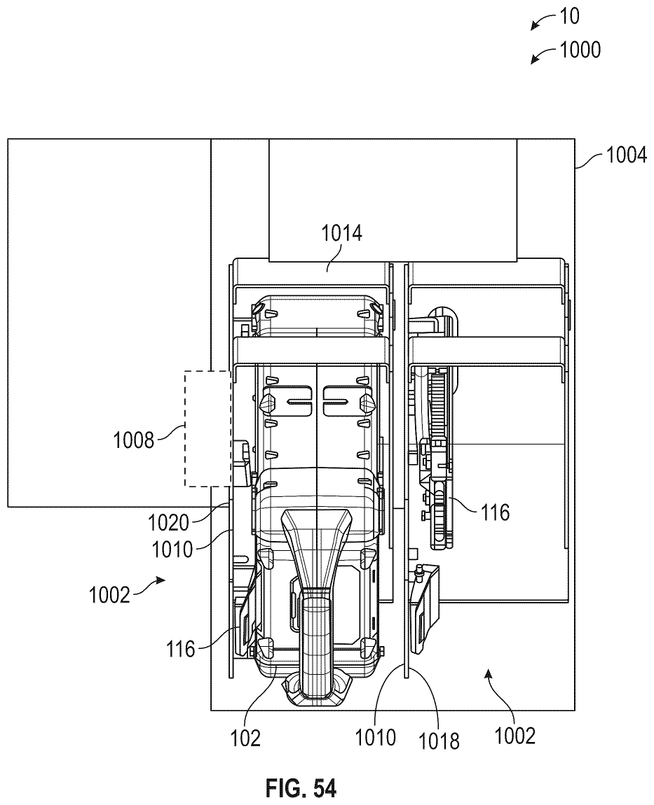

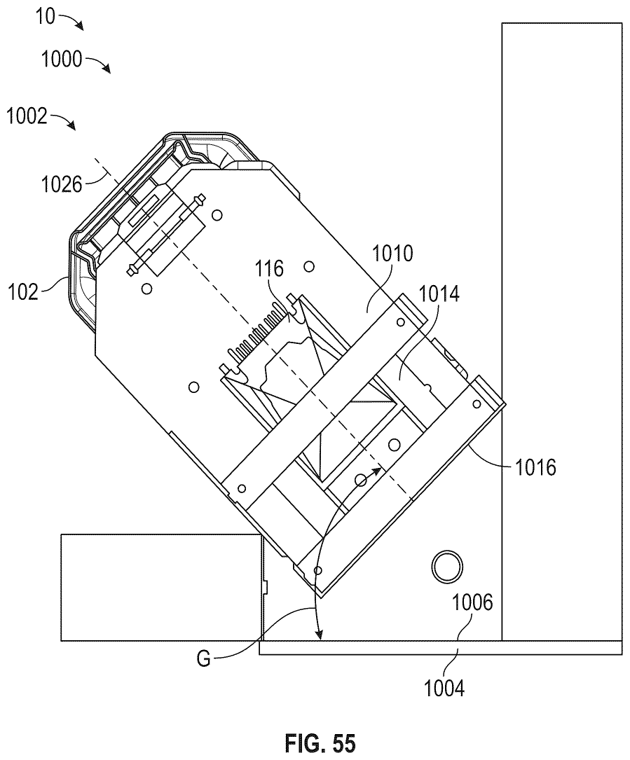

FIGS. 53-55 show the chore product or power equipment 10 in the form of a light tower 1000, according to an exemplary embodiment. The light tower 1000 is powered by the swappable battery pack 102 (e.g., one or more swappable battery packs 102). The swappable battery pack 102 is received within a battery holder or housing 1002. The battery housing 1002 is supported on and coupled to a base 1004 of the light tower 1000. Specifically, the battery housing 1002 is coupled to a mounting surface 1006 (e.g., a top or upper surface) of the base 1004. In some embodiments, a motor controller 1008 (e.g., shown in dashed lines in FIG. 54) is coupled to the battery housing 1002.

In some embodiments, the light tower 1000 includes one or more of the battery housings 1002 supported on the base 1004, each being configured to receive a swappable battery pack 102. The battery housing 1002 includes a first side wall 1010, a second side wall 1012, a bracket 1014, a base wall 1016. The first side wall 1010, the second side wall 1012, the bracket 1014, and the base wall 1016 combined to form a cavity within which the swappable battery pack 102 is received. The bracket 1014 extends from the first side wall 1010 to the second side wall 1012 and includes one more cutouts that aid in increasing airflow past the swappable battery pack 102.

The first side wall 1010 includes an inner surface 1018 and an outer surface 1020. The battery dock connector 116 is coupled to the inner surface 1018. In some embodiments, the motor controller 1008 is coupled to the outer surface 1020. When the swappable battery pack 102 is electrically coupled to and secured by the battery dock connector 116, the swappable battery pack 102 is configured to selectively provide electrical power to a light assembly 1022 of the light tower 1000. In some embodiments, the light tower 1000 may include an electric motor or an electric actuator that is powered by the swappable battery pack 102 and used to raise and lower a telescoping mast 1024 of the light tower 1000.

In the illustrated embodiment, the battery housing 1002 arranges the swappable battery pack 102 at an angle relative to the mounting surface 1006. In the illustrated embodiment, the base wall 1016 is arranged at an angle relative to the mounting surface 1006 of the 1004 so that an axis 1026 extending normal to the base wall 1016 and along a centerline of the swappable battery pack 102 defines an angle G between the mounting surface 1006 and the axis 1026. In the illustrated embodiment, the angle G is not a right angle and the 1016 is not perpendicular to the mounting surface 1006. In some embodiments, the angle G may be an acute angle that is greater than about zero degrees and less than about ninety degrees, or greater than about ten degrees and less than about eighty degrees, or between about twenty degrees and about seventy degrees.

The angled arrangement of the battery housing 1002 arranges the swappable battery pack 102 at the angle G, when the swappable battery pack 102 is installed on or removed from the battery housing 1002. And the angled arrangement of the swappable battery pack 102 on the battery housing 1002 makes installing and removing the swappable battery pack 102 more ergonomic for a user.

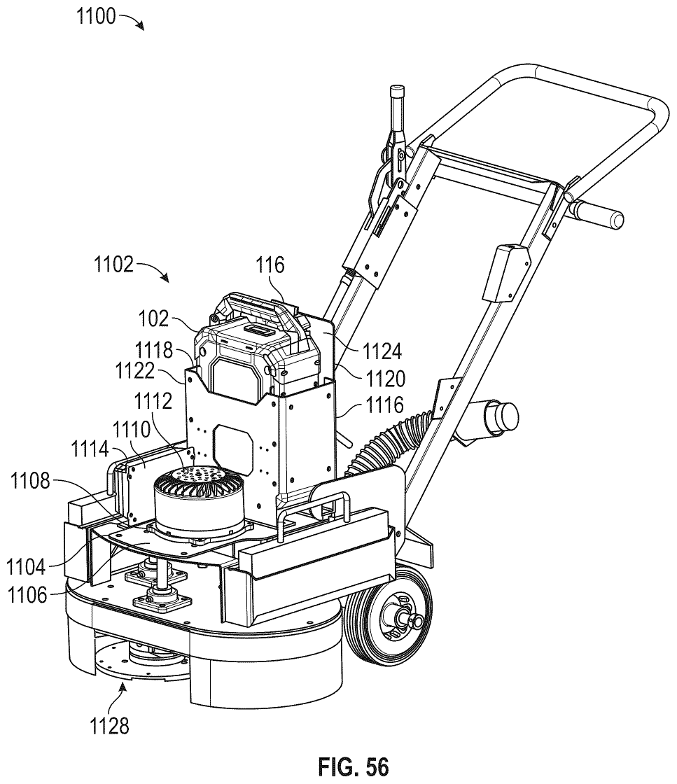

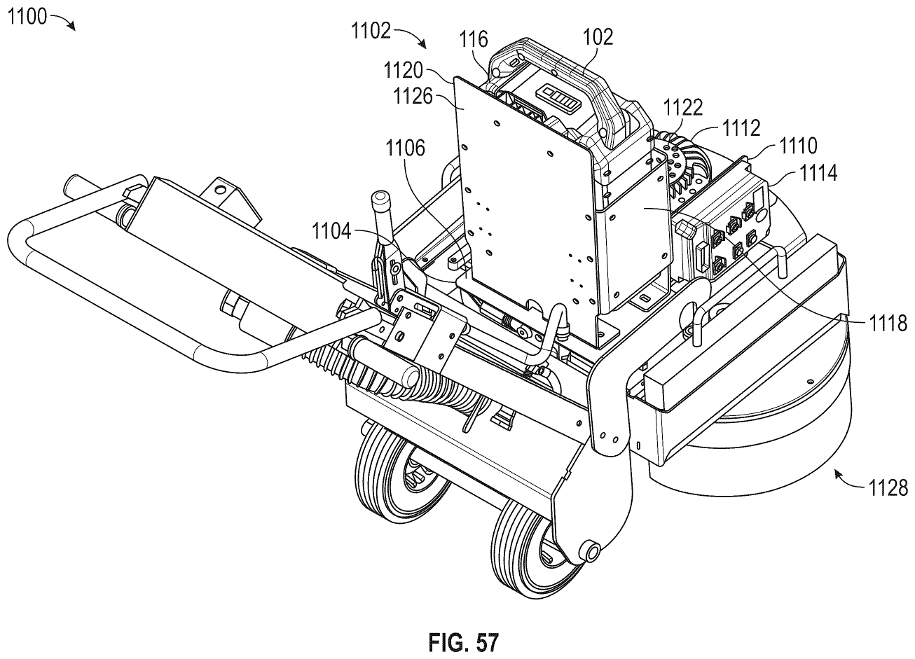

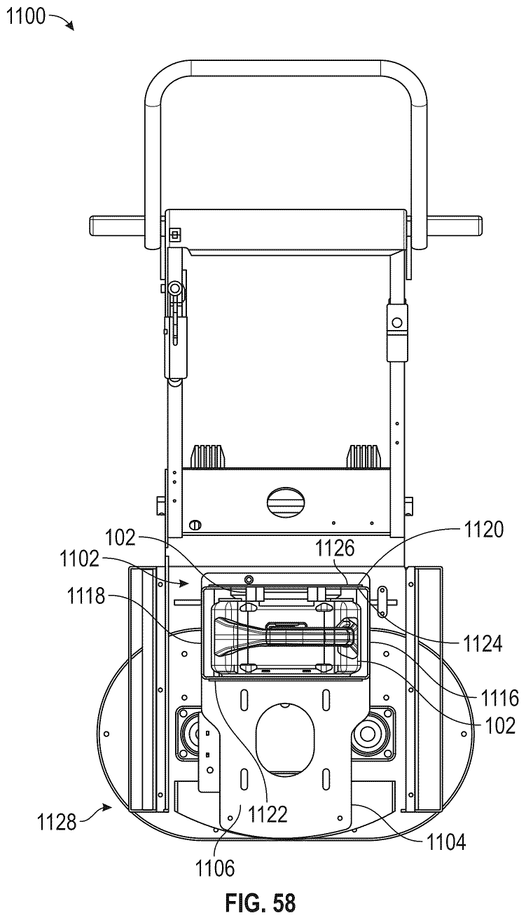

FIGS. 56-58 show the chore product or power equipment 10 in the form of a floor grinder 1100, according to an exemplary embodiment. The floor grinder 1100 is powered by the swappable battery pack 102. The swappable battery pack 102 is received within a battery housing 1102. The battery housing 1102 is coupled to and supported on a body, housing, or base 1104 of the floor grinder 1100. Specifically, the base 1104 includes a mounting surface 1106 (e.g., top or upper surface), a motor mounting bracket 1108, and a motor controller mounting bracket 1110. The motor mounting bracket 1108 supports and is coupled to an electric motor or chore motor 1112. The motor controller mounting bracket 1110 supports and is coupled to a motor controller 1114. In the illustrated embodiment, the motor controller 1114 is coupled to the mounting surface 1106. In some embodiments, the motor controller 1114 may be coupled to the battery housing 1102.

The battery housing 1102 includes a first lateral or right side wall 1116, a second lateral or left side wall 1118, a rear wall or first bracket 1120, and a front wall or second bracket 1122. The right side wall 1116, the left side wall 1118, the rear wall 1120, and the front wall 1122 combine to form a cavity within which the swappable battery pack 102 is received. The right side wall 1116 and the left side wall 1118 each are coupled to and extend between the rear wall 1120 and the front wall 1122, and each the right side wall 1116, the left side wall 1118, and the front wall 1122 include one or more cutouts that aid in increasing airflow past the swappable battery pack 102.

The rear wall 1120 includes an inner surface 1124 and an outer surface 1126. The battery dock connector 116 is coupled to the inner surface 1124. In some embodiments, the motor controller 1114 is coupled to the outer surface 1126. When the swappable battery pack 102 is electrically coupled to and secured by the battery dock connector 116, the swappable battery pack 102 is configured to selectively provide electrical power to a grinder assembly 1128 of the floor grinder 1100.

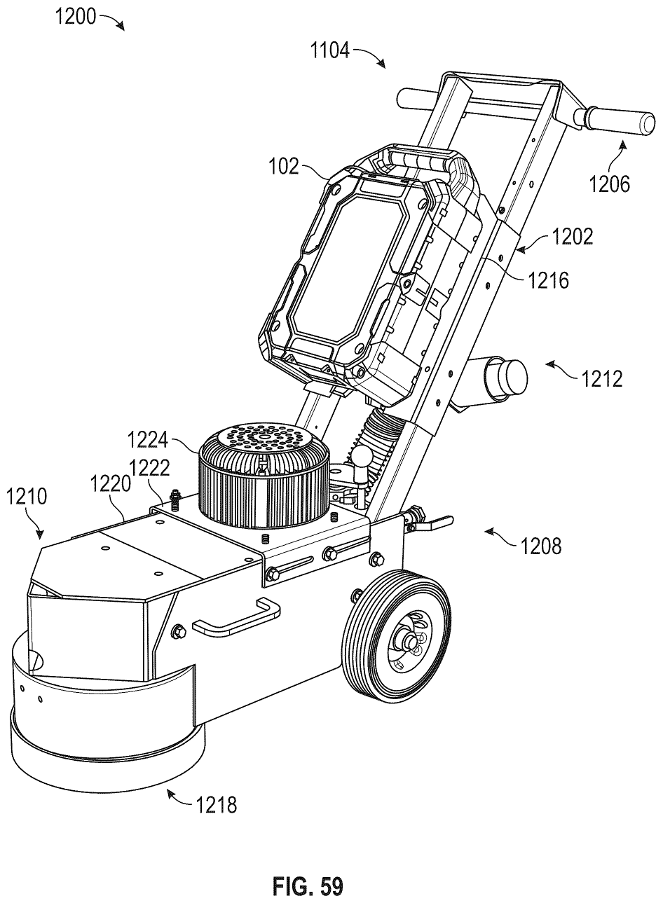

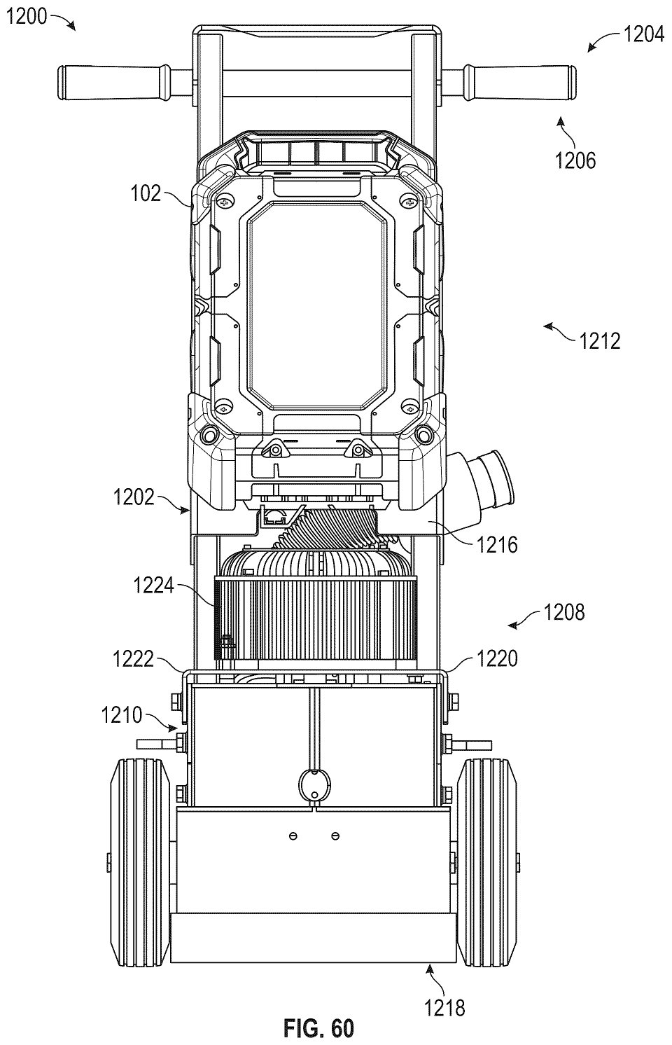

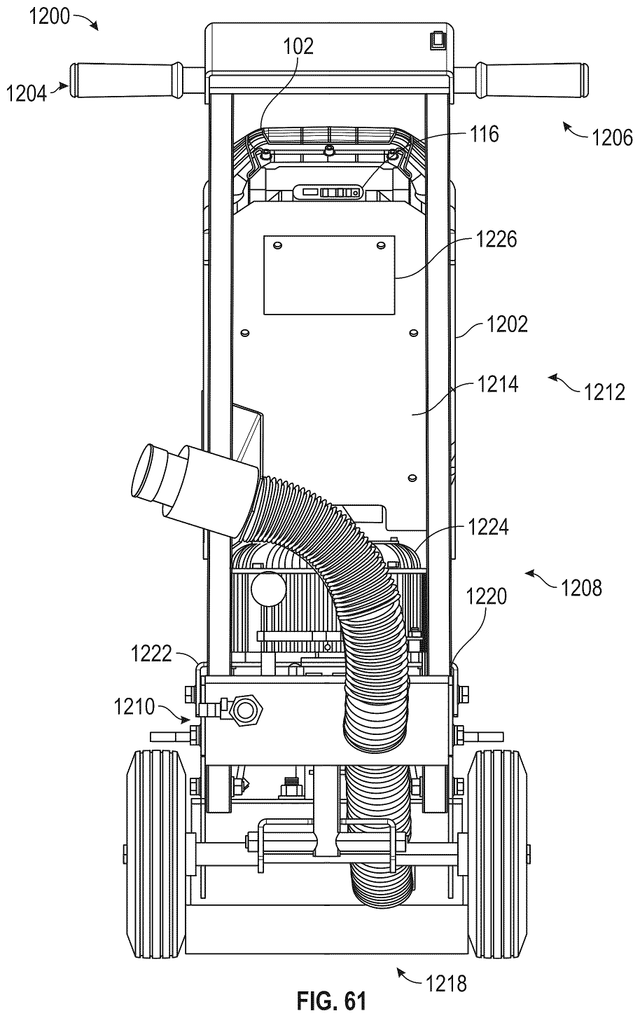

FIGS. 59-63 show the chore product or power equipment 10 in the form of a concrete grinder 1200, according to an exemplary embodiment. The concrete grinder 1200 is powered by the swappable battery pack 102. The swappable battery pack 102 is coupled to and supported on a battery holder or mounting bracket 1202. The battery mounting bracket 1202 is coupled to and supported on a handlebar assembly 1204 of the concrete grinder 1200. Specifically, the handlebar assembly 1204 includes an upper portion 1206 where a user is intended to grip the handlebar assembly 1204, a lower portion 1208 where the handlebar assembly 1204 is coupled to a housing or body 1210 of the concrete grinder 1200, and an intermediate portion 1212 arranged between the upper portion 1206 and the lower portion 1208. The battery mounting bracket 1202 is positioned within the intermediate portion 1212 and extends laterally between one or more rods or bars that extend along the intermediate portion 1212.

The battery mounting bracket 1202 includes an inner, rear, or first surface 1214, which engages the handlebar assembly 1204, and an outer, front, or second surface 1216, which engages the swappable battery pack 102 and is opposite to the inner surface 1214 of the battery mounting bracket 1202. The battery dock connector 116 is coupled to the outer surface 1216 and couples the swappable battery pack 102 to the battery mounting bracket 1202. When the swappable battery pack 102 is electrically coupled to and secured by the battery dock connector 116, the swappable battery pack 102 is configured to selectively provide electrical power to a grinder assembly 1218 of the floor grinder 1100.

The housing 1210 includes one or more mounting surfaces, shown as mounting surface 1220, which engage and support a motor mounting bracket 1222. The motor mounting bracket 1222 supports and is coupled to an electric motor or chore motor 1224. The chore motor 1224 is electrically coupled to a motor controller 1226. In the illustrated embodiment, the motor controller 1226 is coupled to and mounted on the outer surface 1216 of the battery mounting bracket 1202.

In the illustrated embodiment, the outer surface 1216 (e.g., the battery mounting bracket 1202) is arranged at an angle H relative to the mounting surface 1220 of the housing 1210 so that the angle H is not a right angle. In other words, the outer surface 1216 is not perpendicular to the mounting surface 1220, and the angle H may be an obtuse angle that is greater than about ninety degrees and less than about one hundred and sixty degrees, or between about one hundred degrees and about one hundred and fifty degrees.

The angled arrangement of the battery mounting bracket 1202 arranges the swappable battery pack 102 at the angle H (e.g., a center axis extending longitudinally along a centerline of a housing of the swappable battery pack 102 is arranged at the angle H), when the swappable battery pack 102 is installed on or removed from the battery mounting bracket 1202. The angled arrangement of the swappable battery pack 102 on the battery mounting bracket 1202 makes installing and removing the swappable battery pack 102 more ergonomic for a user.

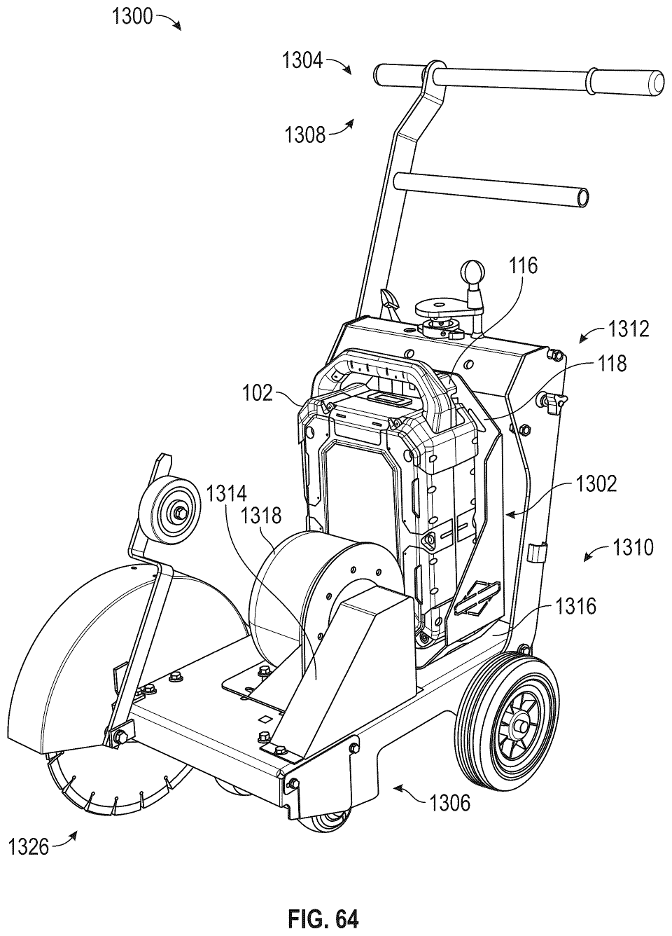

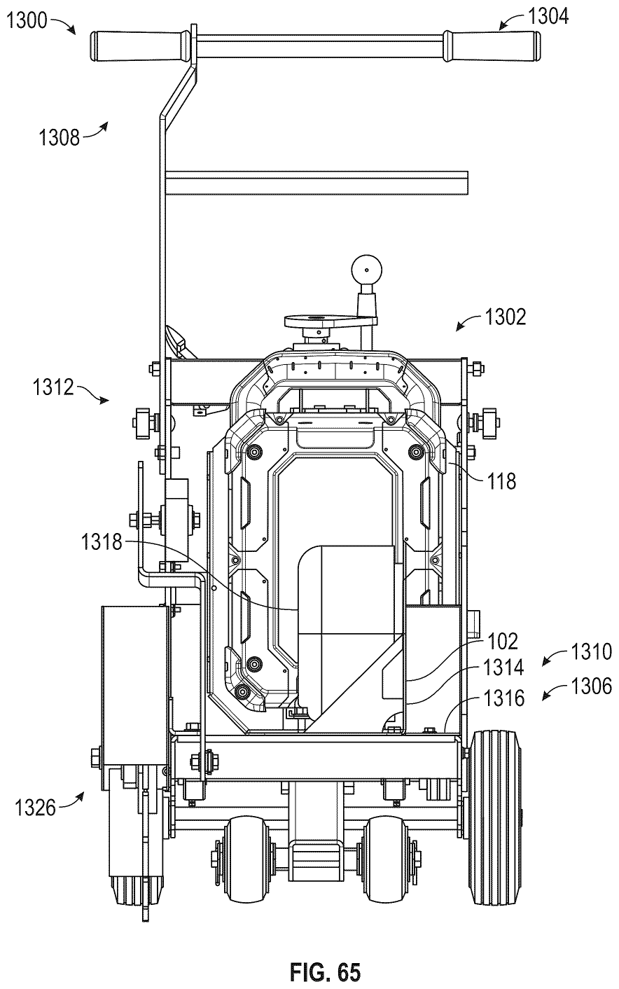

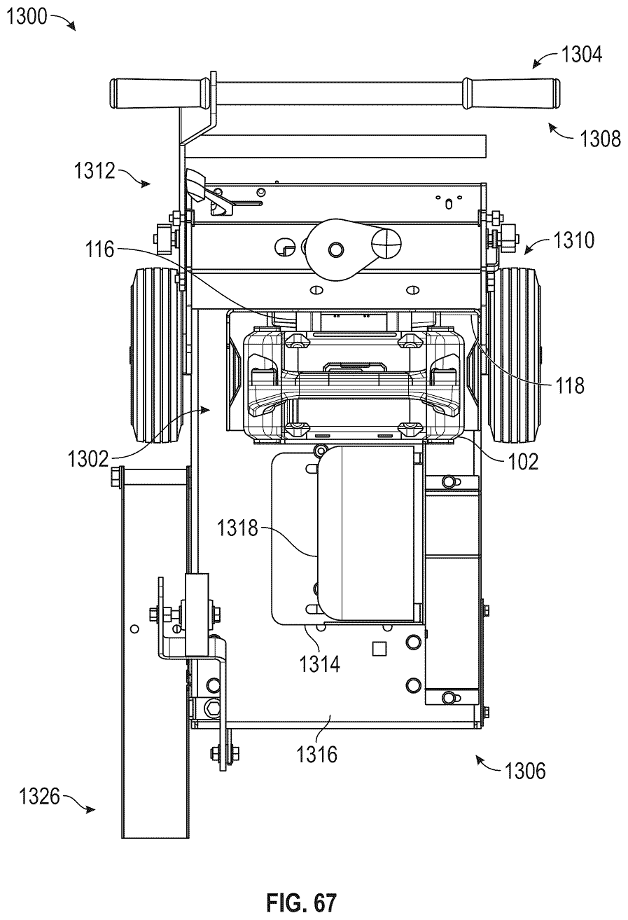

FIGS. 64-67 show the chore product or power equipment 10 in the form of a concrete saw 1300, according to an exemplary embodiment. The concrete saw 1300 is powered by the swappable battery pack 102. The swappable battery pack 102 is received within a battery holder or mounting bracket 1302. The concrete saw 1300 includes a handlebar assembly 1304 and a body or housing 1306. The battery mounting bracket 1302 is coupled to and supported on the housing 1306 of the concrete saw 1300. The handlebar assembly 1304 includes an upper portion 1308 where a user is intended to grip the handlebar assembly 1304, a lower portion 1310 where the handlebar assembly 1304 couples to the housing 1306 of the concrete saw 1300, and an intermediate portion 1312 arranged between the upper portion 1308 and the lower portion 1310. In alternative embodiments, the battery mounting bracket 1302 is arranged between the upper portion 1308 and the lower portion 1310 and coupled to the intermediate portion 1312.

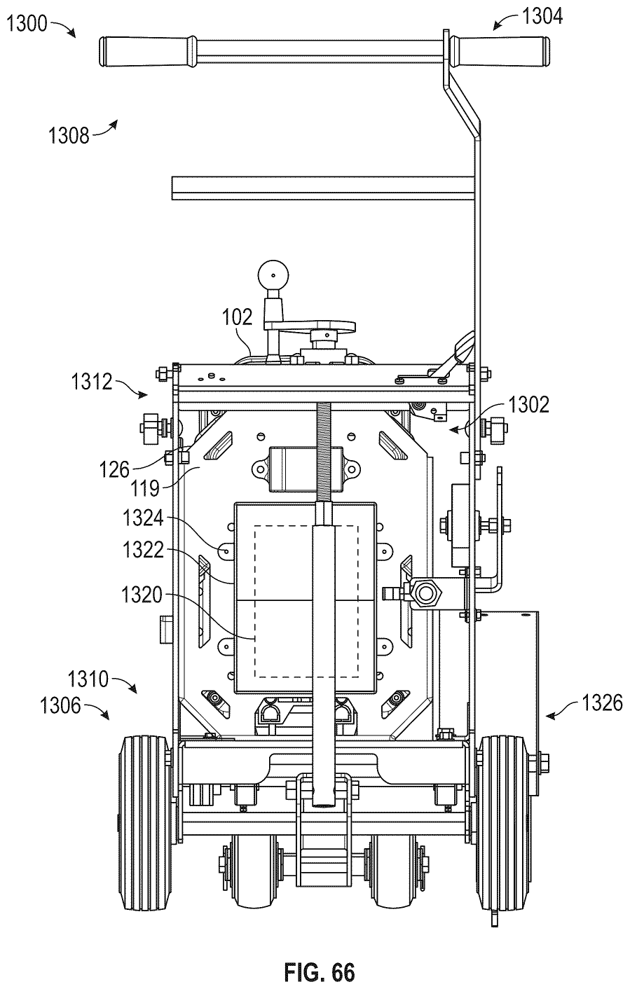

According to the illustrated embodiment, the housing 1306 supports a motor mounting bracket 1314 and the battery mounting bracket 1302. The housing 1306 includes a mounting surface 1316 that engages the motor mounting bracket 1314 and the base wall 132 of the battery mounting bracket 1302. The motor mounting bracket 1314 supports and is coupled to an electric motor or chore motor 1318. In some embodiments, the housing 1306 supports a motor controller 1320. According to the illustrated embodiment, the motor controller 1320 (e.g., shown in dashed lines in FIG. 66) is coupled to and mounted on the outer surface 119 of the battery mounting bracket 1302. The motor controller 1320 may be enclosed or covered on the outer surface 119 by a motor controller housing or cover 1322. The motor controller cover 1322 includes one or more cover apertures 1324 that each align with one of the mounting apertures 134 formed in the rear wall 126 of the battery mounting bracket 1302 to facilitate coupling the motor controller cover 1322 to the battery mounting bracket 1302 by one or more fasteners extending through the mounting apertures 134 and the cover apertures 1324.

In general, the battery mounting bracket 1302 may be similar in design and construction as the battery mounting bracket 104, with like features identified using the same reference numerals, except as described herein or otherwise apparent from the figures. The battery mounting bracket 1302 is coupled to the battery dock connector 116. Specifically, the battery dock connector 116 is coupled to the inner surface 118 of the battery mounting bracket 1302. When the swappable battery pack 102 is electrically coupled to and secured by the battery dock connector 116, the swappable battery pack 102 is configured to selectively provide electrical power to the motor controller 1320 and to the electric motor 1318 (e.g., in response to an ON/OFF switch being activated to an ON position). In general, the swappable battery pack 102 provides electrical power to the electric motor 1318 and the electric motor 1318 provides rotary power to a saw assembly 1326.

In the illustrated embodiment, the battery mounting bracket 1302 is arranged between a handlebar assembly 1304, the housing 1306 and the saw assembly 1326, and the electric motor 1318 is arranged between the battery mounting bracket 1302 and the saw assembly 1326.

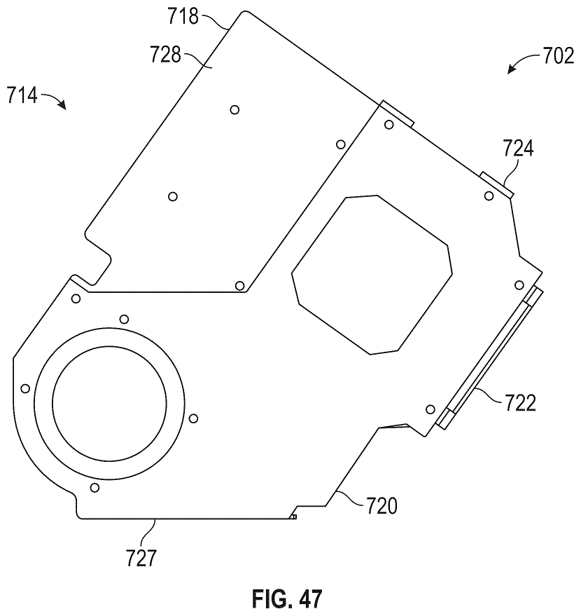

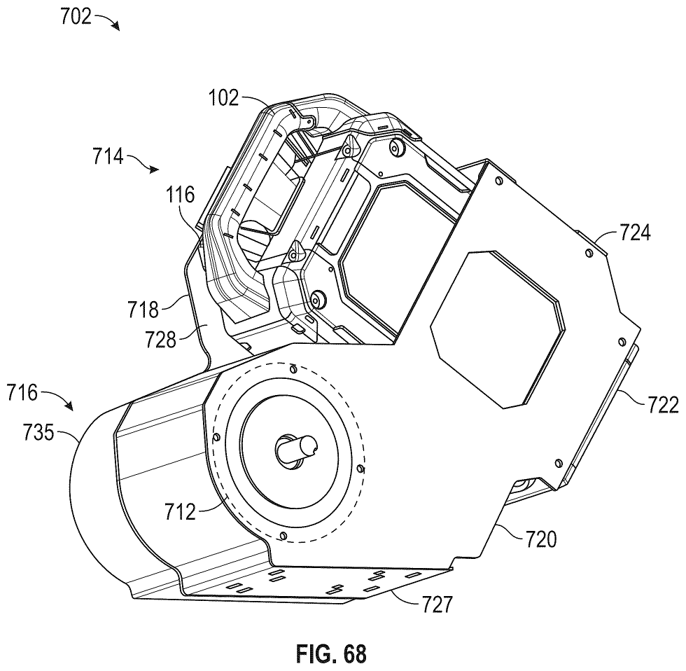

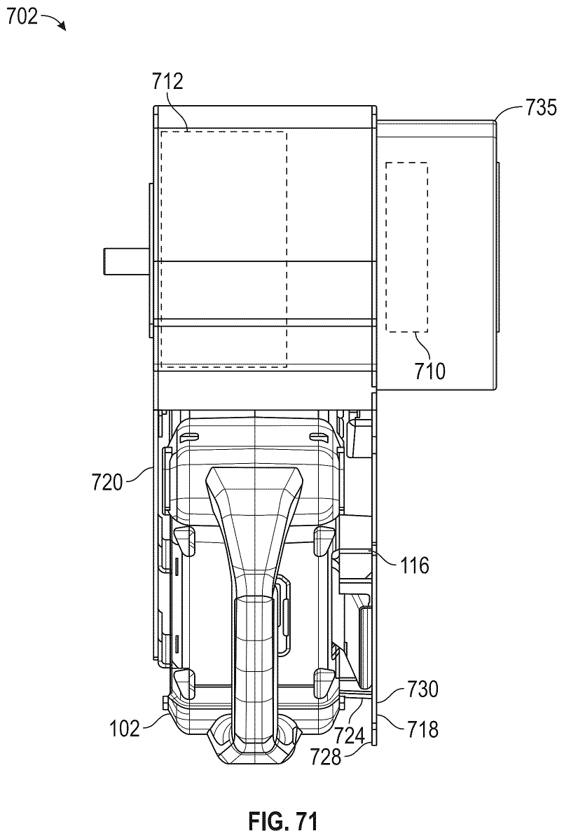

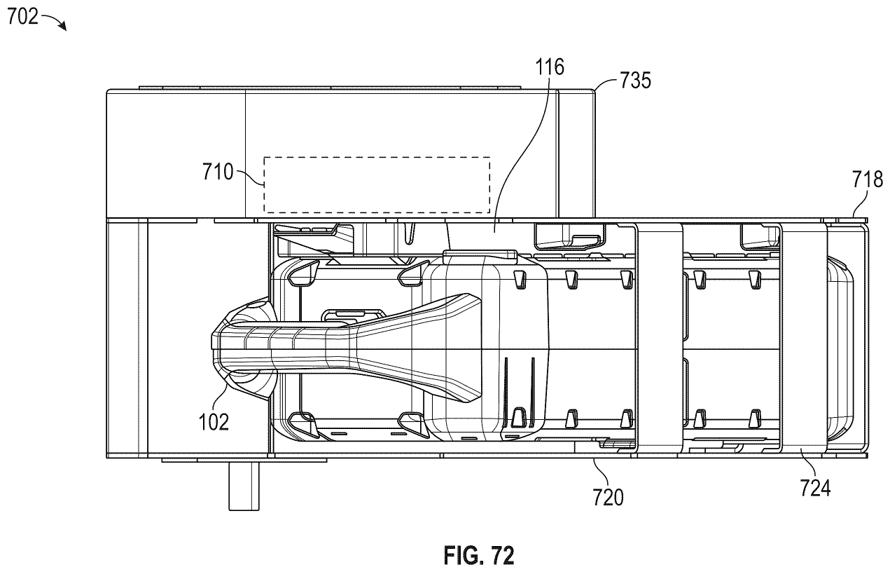

FIGS. 68-72 show the battery housing 702, according to an exemplary embodiment. In general, the battery housing 702 shown in FIGS. 38-52 is similar to the battery housing 702 shown in FIGS. 68-72, with like components identified using the same reference numerals, except as descried herein or as apparent from the figures. Additionally, the battery housing 702 shown in FIGS. 68-72 may be coupled to the chore product or power equipment 10 in the form of the trowel 700, the trowel 800, or the trowel 900.

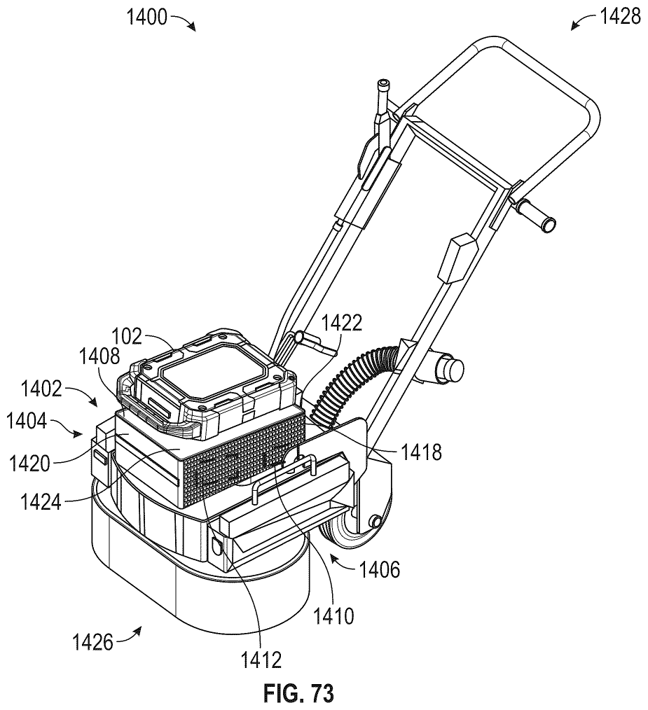

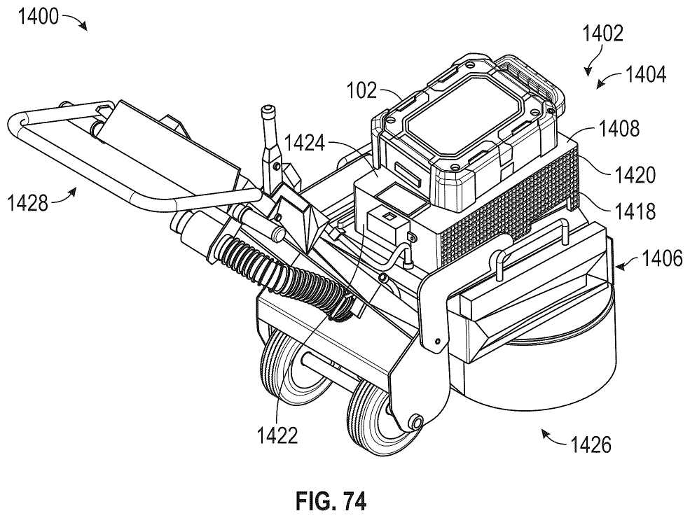

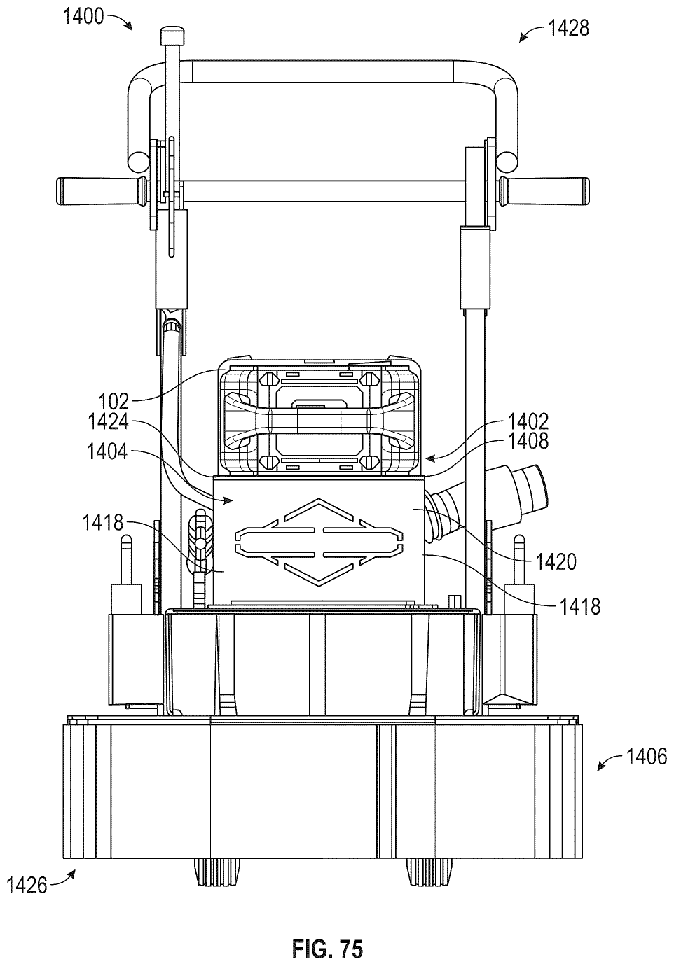

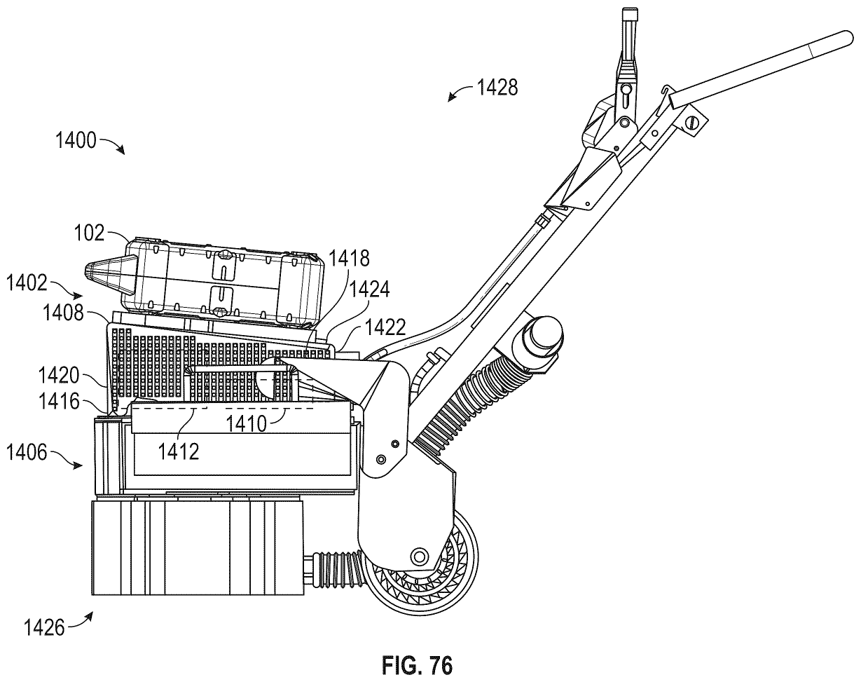

FIGS. 73-76 show the chore product or power equipment 10 in the form of a floor grinder 1400, according to an exemplary embodiment. The floor grinder 1400 is powered by the swappable battery pack 102. The swappable battery pack 102 is received within a battery holder or mounting bracket 1402. The battery mounting bracket 1402 is integrated into or arranged on a motor housing or enclosure 1404 that is coupled to and supported on a body or housing 1406 of the floor grinder 1400. Specifically, an outer surface 1408 (e.g., a top or upper surface) of the motor housing 1404 forms the battery mounting bracket 1402. A motor controller 1410 and an electric motor or chore motor 1412 are at least partially enclosed within the motor housing 1404.

The motor housing 1404 includes a bottom wall 1416, a pair of side walls 1418, a front wall 1420, a rear wall 1422, and a top wall 1424 having the outer surface 1408. The bottom wall 1416, the side walls 1418, the front wall 1420, the rear wall 1422, and the top wall 1424 combine to form an enclosure that encloses the motor controller 1410 and at least partially encloses the electric motor 1412 (e.g., a drive shaft may extend out of the motor housing 1404). In the illustrated embodiment, the motor housing 1404 is coupled to the housing 1406 in a location that is generally between a grinder assembly 1426 and a handlebar assembly 1428, which arranges the swappable battery pack 102 between grinder assembly 1426 and the handlebar assembly 1428.

The battery dock connector 116 is coupled to the outer surface 1408. When the swappable battery pack 102 is electrically coupled to and secured by the battery dock connector 116, the swappable battery pack 102 is configured to selectively provide electrical power to the motor controller 1410 and to the electric motor 1412. When the swappable battery pack 102 is electrically coupled to and secured by the battery dock connector 116, the swappable battery pack 102 is configured to selectively provide electrical power to the grinder assembly 1426 of the floor grinder 1400.

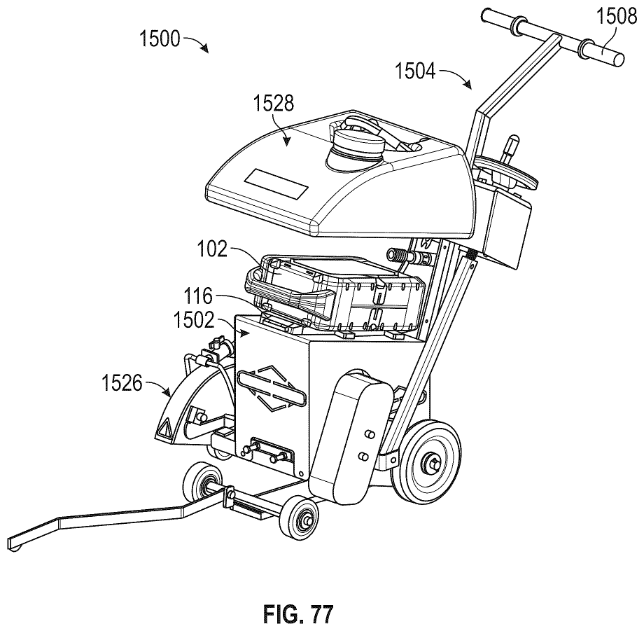

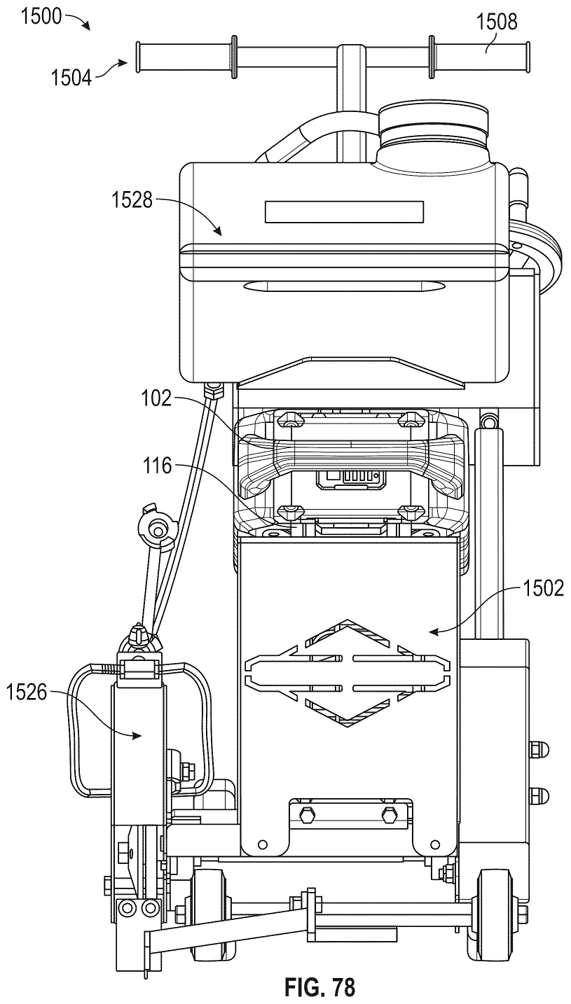

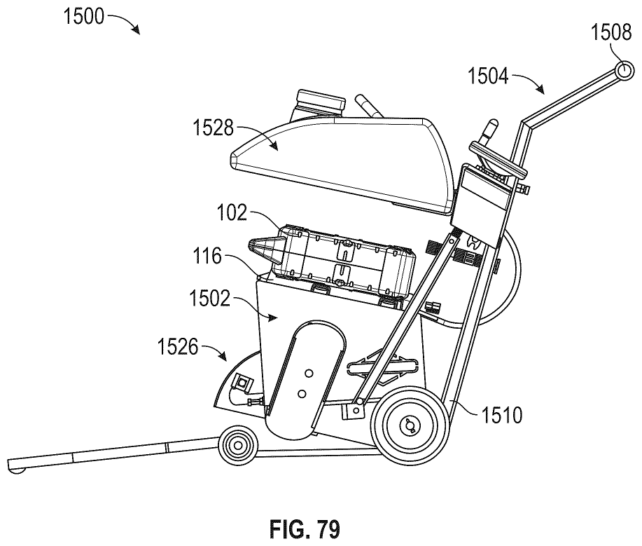

FIGS. 77-80 show the chore product or power equipment 10 in the form of a concrete saw 1500, according to an exemplary embodiment. The concrete saw 1500 is powered by the swappable battery pack 102. The swappable battery pack 102 is received by the battery dock connector 116 and the battery dock connector 116 is mounted on a body or housing 1502. The concrete saw 1500 includes a handlebar assembly 1504 that includes an upper portion 1508 where a user is intended to grip the handlebar assembly 1504, a lower portion 1510 where the handlebar assembly 1504 couples to the housing 1502 of the concrete saw 1500.

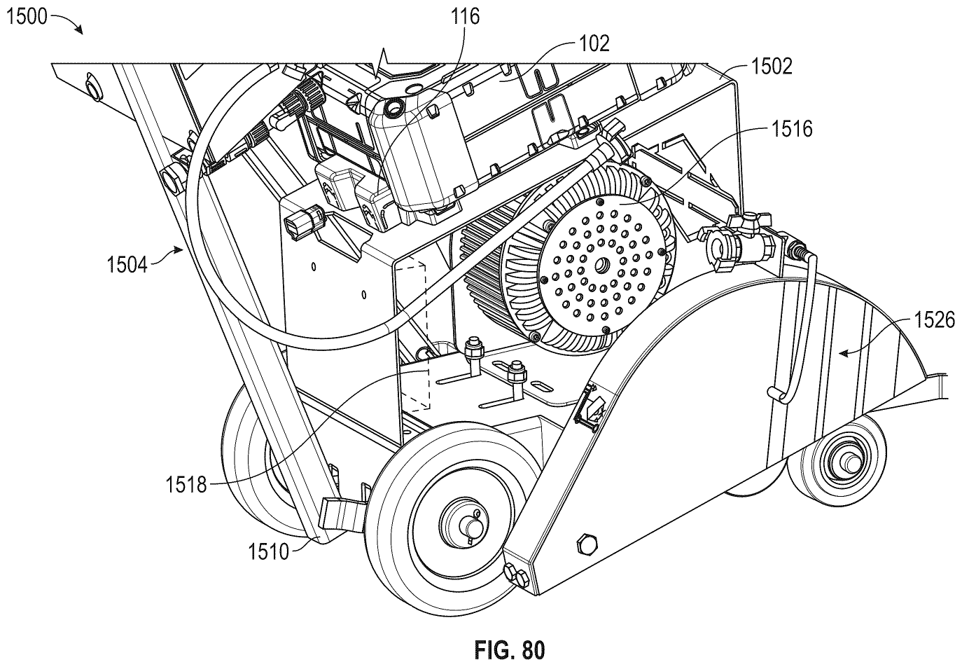

According to the illustrated embodiment, the housing 1502 supports an electric motor or chore motor 1516 that is coupled to and arranged within the housing 1502. Specifically, the electric motor 1516 is coupled to an internal sidewall of the housing 1502, and a motor controller 1518 is coupled to another sidewall of the housing 1502, so that the housing 1502 at least partially encloses both the electric motor 1516 and the motor controller 1518 (e.g., shown in dashed lines in FIG. 80).

When the swappable battery pack 102 is electrically coupled to and secured by the battery dock connector 116, the swappable battery pack 102 is configured to selectively provide electrical power to the motor controller 1518 and to the electric motor 1516 (e.g., in response to an ON/OFF switch being activated to an ON position). In general, the swappable battery pack 102 provides electrical power to the electric motor 1516 and the electric motor 1516 provides rotary power to a saw assembly 1526. In the illustrated embodiment, the swappable battery pack 102 is arranged between a tank 1528 (e.g., a water tank) and the housing 1502. Specifically, the battery dock connector 116 is coupled to an upper surface of the housing 1502 and is arranged below the tank 1528.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the chore product or power equipment 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. Power equipment, comprising:
a base;
a swappable battery pack;
an electric motor powered by the swappable battery pack;
a motor controller electrically coupled to the electric motor; and
a battery holder or bracket coupled to the base, wherein the battery holder includes a dock connector, wherein the swappable battery pack is coupled to the dock connector and arranged within or on the battery holder so that the swappable battery pack is arranged at an angle relative to the base.

2. The power equipment of claim 1, wherein the angle is not a right angle.

3. The power equipment of claim 1, wherein the angle is an acute angle.

4. The power equipment of claim 1, wherein the angle is an obtuse angle.

5. The power equipment of claim 1, wherein the motor controller is coupled to the battery holder.

6. The power equipment of claim 1, wherein the base defines a central axis, and wherein the battery holder and the swappable battery pack are laterally offset from the central axis.

7. Power equipment, comprising:
a swappable battery pack;
an electric motor powered by the swappable battery pack;
a motor controller electrically coupled to the electric motor;
a battery holder including a first sidewall and a second sidewall, wherein the battery holder includes a dock connector coupled to an inner surface of the first sidewall, wherein the swappable battery pack is coupled to the dock connector and arranged within a cavity defined between the first sidewall and the second sidewall; and
a motor controller housing enclosing the motor controller and coupled to an outer surface of the first sidewall.

8. The power equipment of claim 7, wherein the battery holder includes a base wall that arranges the swappable battery pack at an angle relative to a mounting base or surface on which the battery holder is supported.

9. The power equipment of claim 8, wherein the angle is not a right angle.

10. The power equipment of claim 8, wherein the angle is an acute angle.

11. The power equipment of claim 8, wherein the angle is an obtuse angle.

12. The power equipment of claim 8, further comprising a base that defines a central axis, and wherein the battery holder and the swappable battery pack are laterally offset from the central axis.

13. Power equipment, comprising:
a base;
a swappable battery pack;
an electric motor powered by the swappable battery pack;
a motor controller electrically coupled to the electric motor; and
a battery holder or bracket coupled to the base, wherein the battery holder includes a dock connector, wherein the swappable battery pack is coupled to the dock connector and arranged within or on the battery holder, and wherein the base defines a central axis and the battery holder and the swappable battery pack are laterally offset from the central axis.

14. The power equipment of claim 13, wherein the battery holder includes a first sidewall and a second sidewall.

15. The power equipment of claim 14, wherein the dock connector is coupled to an inner surface of the first sidewall.

16. The power equipment of claim 15, wherein the swappable battery pack is coupled to the dock connector and arranged within a cavity defined between the first sidewall and the second sidewall.

17. The power equipment of claim 13, wherein the battery holder includes a base wall that arranges the swappable battery pack at an angle relative to a mounting platform or surface on which the battery holder is supported.

18. The power equipment of claim 17, wherein the angle is not a right angle.

19. The power equipment of claim 17, wherein the angle is an acute angle.

20. The power equipment of claim 17, wherein the angle is an obtuse angle.
